(19) United States
(12) Patent Application Publication
(10) Pub. No.: US 2024/0334540 A1
(43) Pub. Date: Oct. 3, 2024

(54) METHODS AND APPARATUS FOR CONTROLLING THE USE OF PAGING EARLY INDICATION IN PAGING A UE

(71) Applicant: Huawei Technologies Co., Ltd., Shenzhen (CN)

(72) Inventors: Yunsong Yang, San Diego, CA (US); Mazin Ali Al-Shalash, Frisco, TX (US); Hao Bi, Lake Zurich, IL (US)

(21) Appl. No.: 18/737,271

(22) Filed: Jun. 7, 2024

Related U.S. Application Data
(63) Continuation of application No. PCT/US2022/048720, filed on Nov. 2, 2022.
(60) Provisional application No. 63/298,036, filed on Jan. 10, 2022.
(60) Provisional application No. 63/292,310, filed on Dec. 21, 2021.

(51) Int. Cl. H04W 76/28; H04W 68/02

(52) U.S. Cl. CPC H04W 76/28; H04W 68/02

(57) ABSTRACT

According to various embodiments, a method includes determining, by a network node, whether to enable or disable a paging early indication (PEI) function for a user equipment (UE) in accordance with one or more messages the network node received from at least one of a session management function (SMF), a first next generation Node B (gNB), or the UE. The method further includes transmitting, by the network node, an indication to the first gNB, the indication indicating whether the PEI function for the UE is enabled or disabled.

### CROSS-REFERENCE TO RELATED APPLICATIONS

This application is a continuation of PCT/US2022/048720, filed Nov. 2, 2022, and entitled “Methods and Apparatus for Controlling the Use of Paging Early Indication in Paging a UE”, which claims priority to U.S. Provisional Application No. 63/292,310, filed on Dec. 21, 2021 and entitled “Methods and Apparatus for Controlling the Use of Paging Early Indication in Paging a UE,” and U.S. Provisional Application No. 63/298,036, filed on Jan. 10, 2022 and entitled “Controlling the use of paging early indication (PEI) in paging a UE,” applications of which are incorporated by reference herein as if reproduced in their entireties.

### TECHNICAL FIELD

The present disclosure relates generally to methods and apparatus for wireless communications, and, in particular embodiments, to methods and apparatus for paging.

### BACKGROUND

In cellular communications, a network may transmit paging messages to a user equipment (UE) in a power saving state to resume data communications with the UE. To save power consumption of the UE, the network may configure periodic paging discontinuous reception (DRX) cycles, and the UE may monitor paging channels during one paging occasion (PO) per DRX cycle. A paging DRX cycle may also be referred to as a DRX cycle or a paging cycle in the present disclosure. A PO is a set of Physical Downlink Control Channel (PDCCH) monitoring occasions where the UE may receive paging downlink control information (DCI). The number of POs in a DRX cycle is configurable and is broadcasted in the system information (SI), and multiple UEs may be distributed among the POs based on their UE identifiers. A UE may wake up at a predetermined time before its configured PO, measure one or more synchronization signal blocks, demodulate and decode the paging DCI, and demodulate and decode a physical downlink shared channel (PDSCH) scheduled by the paging DCI to retrieves a paging message. But the paging message may be intended for another UE that shares the same PO with the UE. Thus, the UE may waste power for such a false paging alarm.

Paging early indication (PEI) has been proposed to reduce UE power consumption due to the false paging alarm. UEs that monitor the same PO can be further divided into multiple subgroups. A next generation Node B (gNB) may send a PEI, which is also referred to as an early-transmitted paging indication, before sending a paging DCI and an associated paging message. The PEI indicates a subgroup that the intended UE belongs to. With subgrouping and the PEI function enabled on the network side, a UE waking up to receive its paging message and capable of PEI and subgrouping and will first monitor for a PEI. Then, the UE may try to retrieve the paging message only if the PEI indicates the subgroup of the UE. Otherwise, the UE may go back to deep sleep mode and wake up in the next DRX cycle. The ability to resume the deep sleep mode early on and to avoid decoding the paging DCI and the paging message unnecessarily may help the UE save power.

### SUMMARY

According to various embodiments, a method includes determining, by a network node, whether to enable or disable a paging early indication (PEI) function for a user equipment (UE) in accordance with one or more messages the network node received from at least one of a session management function (SMF), a first next generation Node B (gNB), or the UE. The method further includes transmitting, by the network node, an indication to the first gNB, the indication indicating whether the PEI function for the UE is enabled or disabled.

In some embodiments, the network node is an access and mobility management function (AMF), and the AMF, the SMF, and the first gNB are configured to serve the UE.

In some embodiments, the determining whether to enable or disable the PEI function for the UE is based on whether or not a quality of service (QoS) requirement can be satisfied when the PEI function for the UE is enabled.

In some embodiments, the QoS requirement is a most stringent delay requirement among one or more data protocol data unit (PDU) sessions on the UE and is determined in accordance with at least one of a PDU session establishment message, a PDU session modification message, or a PDU session release message from the SMF.

In some embodiments, the method further comprises receiving a request message from the UE, the request message including at least one of a request type information element (IE) and a radio resource control (RRC) establishment cause IE, the request type IE and the RRC establishment cause IE indicating whether a service requested by the UE is an emergency service, wherein the network node determines to enable the PEI function for the UE in response to the service requested being a non-emergency service and the network node determines to disable the PEI function for the UE in response to the service requested being the emergency service.

In some embodiments, the method further comprises receiving a request from the UE, the request indicating whether the UE requests to enable or disable the PEI function, wherein the network node determines to enable the PEI function for the UE in response to the UE requests to enable the PEI function and the network node determines to disable the PEI function for the UE in response to the UE requests to disable the PEI function.

In some embodiments, the indication is included in one of an INITIAL CONTEXT SETUP message, a UE CONTEXT MODIFICATION REQUEST message, a PDU SESSION RESOURCE SETUP REQUEST message, a PDU SESSION RESOURCE MODIFY REQUEST message, a PDU SESSION RESOURCE RELEASE COMMAND message, or a PAGING message transmitted from the network node to the first gNB.

In some embodiments, the method further comprises transmitting the indication to a second gNB, wherein the UE is configured to be handed over from the first gNB to the second gNB, and wherein the indication is included in a HANDOVER REQUEST message transmitted from the network node to the second gNB.

In some embodiments, the method further comprises transmitting the indication to the UE.

In some embodiments, the indication is included in either a SERVICE ACCEPT message or a REGISTRATION ACCEPT transmitted from the network node to the UE.

According to various embodiments, a network node includes a non-transitory memory storage comprising instructions. The network node further includes one or more processors in communication with the non-transitory memory storage, the one or more processors executing the instructions to cause the network node to perform a method of any of the preceding methods.

According to various embodiments, a method includes receiving, by a first gNB, an indication from a network node, the indication indicating whether a PEI function for a UE is enabled or disabled. The method further includes obtaining, by the first gNB, a first paging message for the UE. The method further includes when the PEI function for the UE is enabled, transmitting, by the first gNB, a PEI associated with the first paging message during a PEI occasion of the UE before transmitting the first paging message to the UE, the PEI associated with the first paging message indicating a subgroup that the UE belongs to. The method further includes when the PEI function for the UE is disabled, transmitting, by the first gNB, the first paging message to the UE without transmitting the PEI associated with the first paging message.

In some embodiments, the network node is an AMF configured to serve the UE.

In some embodiments, the first gNB is a serving gNB of the UE, and the indication is included in one of an INITIAL CONTEXT SETUP message, a UE CONTEXT MODIFICATION REQUEST message, a PDU SESSION RESOURCE SETUP REQUEST message, a PDU SESSION RESOURCE MODIFY REQUEST message, a PDU SESSION RESOURCE RELEASE COMMAND message, a first HANDOVER REQUEST message, or a second PAGING message transmitted from the AMF to the first gNB.

In some embodiments, the network node is a second gNB configured to hand over the UE to the first gNB, and the indication is included in a second HANDOVER REQUEST message transmitted from the second gNB to the first gNB.

In some embodiments, the method further comprises transmitting a third HANDOVER REQUEST message to a third gNB, the third HANDOVER REQUEST message including the indication, the first gNB being configured to hand over the UE to the third gNB.

In some embodiments, the method further comprises transmitting a first radio access network (RAN) PAGING message to a fourth gNB, the first RAN paging message including the indication and the first paging message for the UE, the first paging message being generated by the first gNB, the fourth gNB being configured to transmit the first paging message in response to receiving the first RAN PAGING message.

In some embodiments, the method further comprises transmitting the indication to the UE, the indication included in a dedicated RRC signaling.

In some embodiments, the dedicated RRC signaling is either an RRC RELEASE message or an RRC RECONFIGURATION message.

In some embodiments, the method further comprises receiving a second RAN PAGING message from the network node, the network node being a neighboring gNB of the first gNB, the second RAN paging message including the indication and the first paging message for the UE, the first gNB being configured to transmit the first paging message in response to receiving the second RAN PAGING message.

According to various embodiments, a gNB includes a non-transitory memory storage comprising instructions. The gNB further includes one or more processors in communication with the non-transitory memory storage, the one or more processors executing the instructions to cause the gNB to perform a method of any of the preceding methods.

According to various embodiments, a method includes receiving, by a UE, an indication before entering a power saving (PS) state, the indication indicating whether a PEI function for the UE is enabled or disabled. The method further includes entering the PS state. The method further includes in response to determining that the PEI function for the UE is enabled, monitoring a PEI occasion scheduled by a cell that supports the PEI function, the UE currently camping in the cell. The method further includes in response to determining that the PEI function for the UE is disabled, monitoring a paging occasion (PO) scheduled by the cell for paging downlink control information (DCI).

In some embodiments, the method further comprises determining whether or not a PEI is received during the PEI occasion.

In some embodiments, the method further comprises in response to determining that the PEI is not received during the PEI occasion or that the PEI is received during the PEI occasion and the PEI does not indicate a subgroup associated with the UE, returning to a sleep mode until a next PEI occasion.

In some embodiments, the method further comprises in response to determining that the PEI is received during the PEI occasion and the PEI indicates a subgroup associated with the UE, monitoring the PO associated with the PEI for the paging DCI.

In some embodiments, the method further comprises receiving the paging DCI. The method further comprises demodulating and decoding a physical downlink shared channel (PDSCH) in accordance with scheduling information included in the paging DCI to retrieve a paging message. The method further comprises in response to determining that the paging message includes an identity of the UE, initiating a random access procedure.

In some embodiments, the PS state is an RRC_IDLE state or an RRC_INACTIVE state.

In some embodiments, the indication is included in one of an RRC RELEASE message or an RRC RECONFIGURATION message transmitted from a gNB serving the UE.

In some embodiments, the indication is included in one of a REGISTRATION ACCEPT message or a SERVICE ACCEPT message transmitted from an AMF serving the UE.

In some embodiments, the method further comprises transmitting a request to the AMF to either enable or disable the PEI function for the UE before receiving the indication, the request being included in one of a SERVICE REQUEST message or a REGISTRATION REQUEST message transmitted to the AMF.

According to various embodiments, a UE includes a non-transitory memory storage comprising instructions. The UE further includes one or more processors in communication with the non-transitory memory storage, the one or more processors executing the instructions to cause the UE to perform a method of any of the preceding methods.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a sequence of events in paging reception in accordance with some embodiments;

FIG. 2 illustrates a sequence of events in paging reception using a paging early indication (PEI) function in accordance with some embodiments;

FIG. 3 illustrates a message sequence chart showing communications between a

next generation Node B (gNB) and a user equipment (UE) using a UE identity (UEID)-based subgrouping method in accordance with some embodiments;

FIG. 4 illustrates a message sequence chart for assigning a UE to a core network (CN)-assigned subgroup according to some embodiments;

FIG. 5 illustrates an example of paging queuing delay increased by the PEI function;

FIGS. 6A-C and 6F-I illustrate various message sequence charts showing communications between an access and mobility management function (AMF) and one or more radio access network (RAN) nodes for configuring the RAN node according to some embodiments;

FIGS. 6D-E illustrate various message sequence charts showing communications between a first RAN node and a second RAN node for configuring the second RAN node according to some embodiments;

FIGS. 7A-B illustrate various message sequence charts showing communications between an AMF and a UE for configuring the UE according to some embodiments;

FIGS. 7C-D illustrate various message sequence charts showing communications between a gNB and a UE for configuring the UE according to some embodiments;

FIG. 8 illustrates a flow chart of operations occurring in an AMF according to some embodiments;

FIG. 9 illustrates a flow chart of operations occurring in a gNB according to some embodiments;

FIG. 10 illustrates a flow chart of operations occurring in a UE according to some embodiments;

FIG. 11 illustrates another flow chart of operations occurring in a UE according to some embodiments;

FIG. 12 illustrates yet another flow chart of operations occurring in a UE according to some embodiments;

FIG. 13 illustrates an example communication system;

FIGS. 14A-B illustrate example devices that may implement the methods and teachings according to this disclosure;

FIG. 15 illustrates a block diagram of a computing system that may be used for implementing the devices and methods disclosed herein;

FIG. 16 illustrates another example communications system;

FIG. 17 illustrates a method performed by a network node according to some embodiments;

FIG. 18 illustrates a method performed by a gNB according to some embodiments; and

FIG. 19 illustrates a method performed by a UE according to some embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions, and alterations can be made herein without departing from the spirit and scope of this disclosure as defined by the appended claims.

Although the PEI function may reduce false paging alarms for UEs in power saving state and hence reduce power consumption of these UEs, this function may cause an increased paging queuing delay. For example, when the PEI function is enabled, a UE may receive a PEI during a PEI occasion (PEI-O) ahead of a PO configured for the UE in each paging cycle. When a paging message intended for the UE arrives at a gNB after the PEI-O but before the PO of the UE in a current paging cycle, the gNB may postpone paging the UE till the next paging cycle if no PEI has been sent at the PEI-O of the current paging cycle. In this example, the paging queuing delay is increased by one paging cycle comparing to the case without PEI where the gNB would still transmit the paging message to the UE in the PO of the current paging cycle.

Some mission-critical data services, such as data services in smart-grid, industrial internet of things (IoT), remote control, push-to-talk, and data or positioning services for emergency personnel, may not tolerate a long paging delay, which may include a paging queuing delay in paging a UE and a delay in the UE responding to the paging. For these services, the increased paging queuing delay caused by the PEI function may not be acceptable. Therefore, the network may need to control (enable or disable) the use of PEI in paging a UE based on whether the service running on the UE can tolerate the increased paging queuing delay caused by the PEI.

However, in a conventional communication system, both core network (CN) nodes and radio access network (RAN) nodes may not be able to disable the PEI function and the subgrouping for an individual UE. For example, the CN may avoid subgrouping a UE by not assigning a subgroup identity to the UE. But both the UE and a gNB serving the UE may still support UEID-based subgrouping. To disable the UEID-based subgrouping for the UE, the gNB may need to stop broadcasting a total number of UEID-based subgroups in a cell, which will disable the PEI function for all the UEs in the cell. Thus, advanced techniques that allow the network to enable or disable the PEI function for each individual UE in a flexible manner are desired.

In various embodiments of the present disclosure, a network node may determine whether to enable or disable a PEI function for a UE in accordance with one or more messages the network node received. The network node may enable or disable the PEI function for the UE based on a quality of service (QoS) requirement, which is determined in accordance with a protocol data unit (PDU) session establish, modify, or release message the network node received from a CN node. The network node also may enable or disable the PEI function for the UE based on a service type of a service being established or modified on the UE or being released from the UE. The network node also may enable or disable the PEI function for the UE based on a type of the UE or a request transmitted from the UE. Furthermore, the network node may transmit an indication to a gNB to indicate whether the PEI function for the UE is enabled or disabled. The network node also may transmit the indication to the UE. In so doing, embodiment techniques provide the network with flexibility to balance a need to meet a delay requirement and a need to reduce the power consumption of the UE. In addition, such control may be adjusted dynamically when a PDU session with a delay requirement is added, released, or modified. The above aspects and other embodiment aspects are discussed in greater detail below.

Paging messages are sent by the network to reach UEs in a power saving (PS) state, such as an RRC_IDLE or RRC_INACTIVE state, in order to resume data communications with the UEs. UEs in the RRC_IDLE state monitor paging channels for CN-initiated paging. UEs in the RRC_INACTIVE state monitor paging channels for both CN-initiated paging and RAN-initiated paging.

Paging DRX is a UE power saving mechanism where periodic paging DRX cycles are configured by the network for a UE in RRC_IDLE or RRC_ INACTIVE state, and the UE may monitor paging channels only during one PO per DRX cycle. A PO is a set of PDCCH monitoring occasions and may consist of multiple time slots where paging DCI may be sent. A time slot may be a slot, which may equal to multiple orthogonal frequency-division multiplexing (OFDM) symbols, a subframe (which may be 1 millisecond or may be defined as one or more slots depending on the numerology), or an OFDM symbol. The number of POs in a DRX cycle is configurable and is broadcasted in the SI. When multiple POs are configured per DRX cycle, UEs are distributed among the POs based on their UEIDs.

For CN-initiated paging, a default DRX cycle is broadcasted in the SI, and a UE-specific DRX cycle can be configured via non-access stratum (NAS) signaling. For RAN-initiated paging, a UE-specific DRX cycle is configured via radio resource control (RRC) signaling. UEs may use the shortest of the DRX cycles applicable. For example, a UE in RRC_IDLE state may use the shortest of the first two DRX cycles aforementioned (i.e., the default DRX cycle in the SI and, if configured, the UE-specific DRX cycle in the NAS signaling). In another example, a UE in RRC_INACTIVE state may use the shortest of the three DRX cycles.

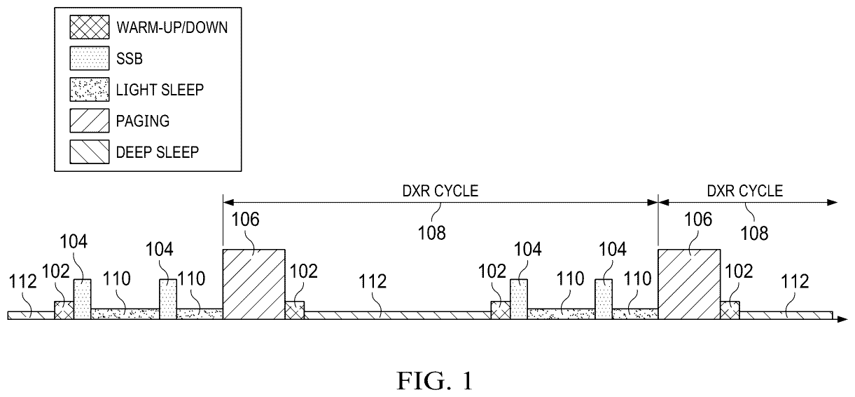

FIG. 1 illustrates a sequence of events in paging reception in accordance with some embodiments. A UE may perform the following steps in monitoring its paging messages.
Step 1: The UE wakes up at a predetermined time before its associated PO 106 and turns on components in preparation for data reception during a time period 102. In other words, the UE is warming up during time period 102.
Step 2: The UE measures one or more synchronization signal blocks (SSBs) 104 to estimate time and frequency offsets for the purpose of achieving time and frequency synchronization in Step 3. The estimation may require the measurements of the one or more SSBs 104. For example, the UE may wake up two SSBs ahead of its associated PO 106 and uses the measurements of the two SSBs to estimate the time and frequency offsets. The UE may determine a required number of SSB measurements based on the signal level or signal quality of the SSB(s) measured during one or more previous DRX cycles 108. The UE may enter a light sleep mode 110 between SSB measurements 104 and/or between the final SSB measurement 104 and the associated PO 106 for power saving.
Step 3: The UE performs time and frequency compensation in receiving signals.
Step 4: At the associated PO 106, the UE demodulates and decodes paging DCI from PDCCH with cyclic redundancy check (CRC) scrambled by paging radio network temporary identifier (P-RNTI). If no paging DCI is correctly decoded, the UE determines that there is no paging message being scheduled in the current PO 106, and based thereon, the UE resumes a deep sleep mode 112 until a time to warm up for the next DRX cycle.
Step 5: If the paging DCI is correctly decoded in step 4, the UE demodulates and decodes the PDSCH as scheduled by the paging DCI and retrieves the paging message from the correctly decoded PDSCH.
Step 6: Then, the UE determines whether its UEID is included in the paging message or not. If the UEID is included in the paging message, the UE determines that it is being paged, and based thereon, performs subsequent steps accordingly, e.g., sending a random access preamble on a physical random access channel (PRACH) to the gNB, etc. If the UEID is not included in the paging message, the UE determines that the paging DCI received is simply a false alarm (i.e., the paging message scheduled by the paging DCI is intended for another UE sharing the same PO), and based thereon, the UE resumes the deep sleep mode 112 until a time to warm up for the next DRX cycle. It is noted that when a false paging alarm occurs, the UE wastes its power in decoding the PDSCH that carries a paging message unintended for the UE.

### UE Subgrouping for Paging Enhancement

To reduce power consumption in UEs due to false paging alarms, UEs monitoring a same PO can be further divided into multiple subgroups. To page a UE capable of PEI and subgrouping, before sending the paging DCI on the PDCCH during a PO and the associated paging message on the PDSCH, the gNB sends a PEI on the PDCCH, where the PEI indicates the subgroup that the intended UE belongs to.

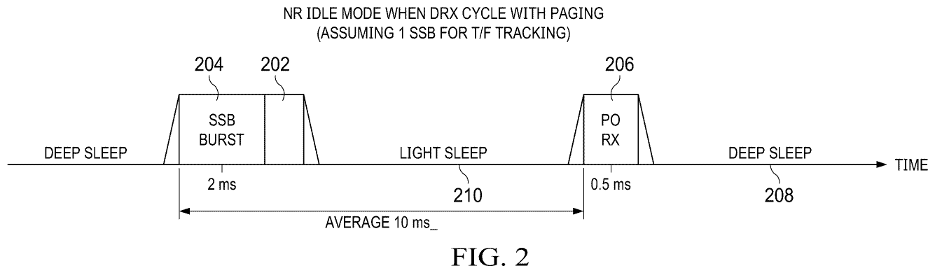

FIG. 2 illustrates a sequence of events in paging reception using a PEI function in accordance with some embodiments. With subgrouping and PEI enabled on the network side, a UE waking up to receive its paging message monitors for a PEI 202, e.g., carried on PDCCH, after correcting its time and frequency offsets. The searching for the PDCCH carrying the PEI 202 is done over a preconfigured search space. For example, the first PDCCH monitoring occasion of the PEI 202 can be configured as the L-th SSB 204 before the first PDCCH monitoring occasion of a target PO 206, where L=1, 2, or 3, which translates into an additional amount of paging queuing latency of 10, 30, or 50 milli-seconds (msec or ms), given that the inter-SSB interval is 20 msec. When receiving the PEI 202, the UE determines whether the PEI 202 indicates the subgroup that it belongs to. If its subgroup is indicated in the received PEI 202, the UE demodulates and decodes the paging DCI on the PDCCH at its associated PO 206 and the paging message on the PDSCH (based on the scheduling information carried on the paging DCI) and then checks whether the paging message includes its UEID in order to determine whether it is being paged or not. If its subgroup is not indicated in the received PEI 202 or if no PEI is received, the UE determines that there will be no paging message intended for it in the associated PO 206, and based thereon, immediately resumes a deep sleep mode 208 until a time to monitor the PEI during the next DRX cycle and thereby avoids decoding paging DCI and paging message that might be in the associated PO 206 but are unintended for the UE. In this situation, the UE is able to resume the deep sleep mode early on, instead of entering a light sleep mode 210 between the SSB measurement 204 and the associated PO 206. The ability to resume the deep sleep mode early on and to avoid decoding paging DCI and paging message that are unintended for the UE helps the UE to save its power significantly.

There are at least two subgrouping methods: UEID-based subgrouping method and CN-assigned subgrouping method.

### UEID-Based Subgrouping Method

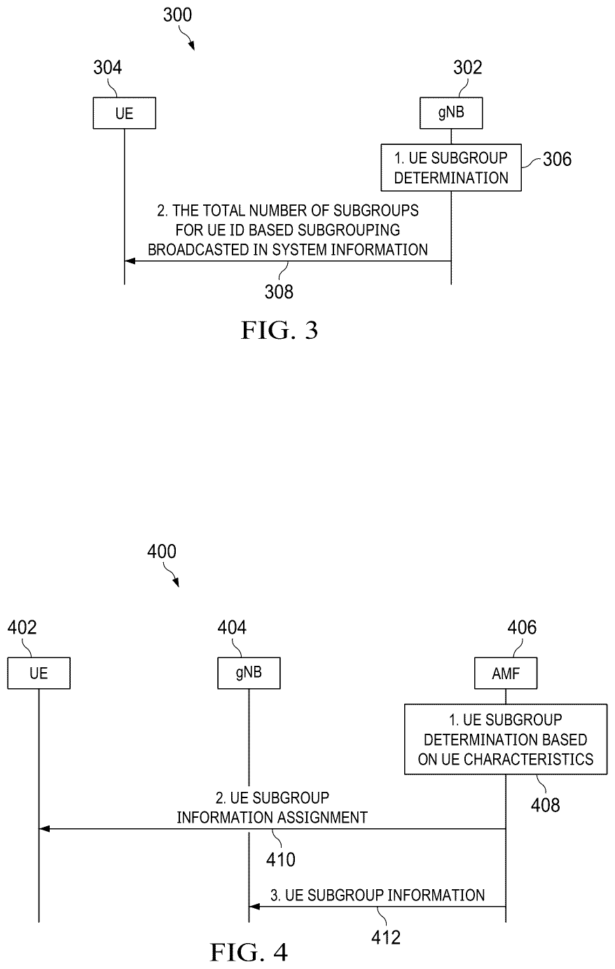

FIG. 3 illustrates a message sequence chart 300 showing communications between a gNB 302 and a UE 304 using a UEID-based subgrouping method in accordance with some embodiments. In step 306, the gNB 302 determines a total number of UEID-based subgroups supported in the cell, which number may be different for different cells. In step 308, the gNB 302 broadcasts the total number of UEID-based subgroups supported in the cell in the SI. Then, the gNB 302 (when having a need to page the UE 304) and the UE 304 (when camping under the gNB 302) each determines a subgroup ID of the UE by hashing the UE's UEID based on the total number of UEID-based subgroups supported in the cell. A simple example of the hashing operation is a modulo operation, which returns a remainder of a division after dividing the UEID by the total number of UEID-based subgroups.

Although the UEID-based subgrouping method is simple, when a first UE with a low paging probability and a second UE with a high paging probability happen to be hashed to a same subgroup associated with a same PO, the first UE bears false paging alarms caused by the paging massages intended for the second UE more frequently than the second UE bears false paging alarms caused by the paging massages intended for the first UE. Therefore, using UEID-based subgrouping method, different UEs may suffer from false paging alarms unevenly.

### CN-Assigned Subgrouping Method

In CN-assigned subgrouping, an access and mobility management function (AMF), which is a CN node, is responsible for assigning a UE to a subgroup based on certain characteristics of the UE, such as a paging probability of the UE, a power profile of the UE, etc. The power profile may include information of power source (such as utility power, battery, renewable energy, etc.), a battery size, a battery remaining power status, an estimated power consumption rate, etc.

FIG. 4 illustrates a message sequence chart 400 for assigning a UE 402 to a CN-assigned subgroup according to some embodiments. In step 408, an AMF 406 determines the UE subgroup information, including a subgroup ID assigned to the UE 402, based on certain characteristics of the UE 402. In step 410, the AMF 406 sends the UE subgroup information to the UE 402 via NAS signaling. In step 412, the AMF 406 informs one or more gNBs 404 about the UE subgroup information for paging the UE 402 when the UE 402 is in the RRC_IDLE or RRC_INACTIVE state. For example, for CN-initiated paging, the AMF 406 sends a paging message intended for the UE 402, along with the UE subgroup information, to the one or more gNBs 404 when the AMF 406 requests the one or more gNBs 404 to page the UE 402. For another example, for RAN-initiated paging, the AMF 406 informs an anchor gNB of the UE 402 (which is also referred to as the last serving gNB of the UE 402) about the UE subgroup information before the anchor gNB releases the UE 402 into the RRC_INACTIVE state, the UE subgroup information being stored at the anchor gNB as a part of the UE Context of the UE 402. And when the anchor gNB needs to request its neighboring gNB(s) to participate in an effort of paging the UE 402, the anchor gNB sends the RAN-initiated paging message, along with the UE subgroup information, to its neighboring gNB(s).

The CN-assigned subgrouping method provides the network with the flexibility to group UEs with similar characteristics (such as paging probability or power profile) into a same subgroup while separating UEs with different characteristics by assigning them to different subgroups. The AMF may estimate a UE's paging probability based on a service type or a paging history of the UE. The AMF may obtain a UE's power profile information based on a UE type or a UE assistance information (UAI) sent by the UE, the UAI including the power profile information of the UE.

Comparing to the UEID-based subgrouping method, the CN-assigned subgrouping method is more complex (because more network nodes are involved and more signaling exchanges are required) but allows the network to optimize the power performance of UEs in RRC_IDLE or RRC_INACTIVE state, especially those UEs that are vulnerable to false paging alarms in terms of power consumption, e.g., UEs that are rarely paged but are power-sensitive. Hence, a primary goal for using the CN-assigned subgrouping may be to protect those vulnerable UEs, e.g., from non-vulnerable UEs or UEs with high paging frequency.

Although the use of PEI with UE subgrouping may reduce false paging alarms for UEs in RRC_IDLE or RRC_INACTIVE state and hence reducing power consumption for these UEs, such benefit comes with a price of increased paging queuing delay, as explained below.

Paging DRX cycle can be configured for a UE with a duration of 10, 20, 32, 40, 60, 64, 70, 80, 128, 160, 256, 320, 512, 640, 1280, 2560, 5120, or 10240 msec. Without the use of PEI, assuming the duration of the PO of the UE is negligible comparing to the duration of the paging DRX cycle, the average paging queuing delay approximately equals to one half of the duration of the paging DRX cycle, hence ranging from 5 to 5120 msec, depending on the duration of the paging DRX cycle.

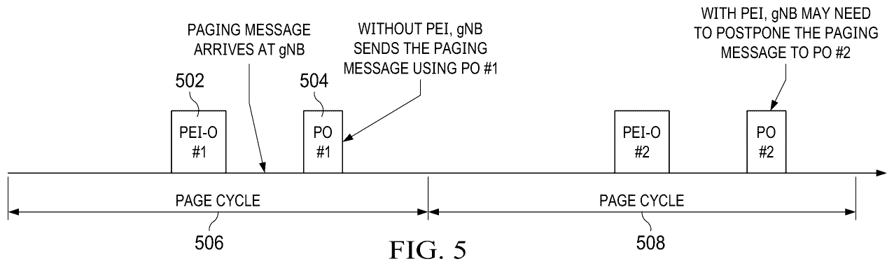

FIG. 5 illustrates an example of paging queuing delay increased by the PEI function. With the use of PEI, a PEI occasion (PEI-O) of a UE may be configured by the network to be 10, 30, or 50 msec ahead of a PO (which location is also configured by the network) of the UE in each paging cycle, as previously described. As illustrated in FIG. 5, when a paging message intended for the UE arrives at (in the case of CN-initiated paging) or is generated by (in the case of RAN-initiated paging) the gNB after a PEI-O 502 of the UE but still before a PO 504 of the UE within a current paging cycle 506, the gNB first determines whether a PEI has been sent at the PEI-O 502 of the UE within the current paging cycle 506, e.g., due to a need to page a second UE. If a PEI has been sent at the PEI-O 502 and the PEI sent happens to indicate the subgroup of the UE (e.g., due to the second UE happens to share the same PO and the same subgroup with the UE), the gNB can send the paging message to page the UE using the PO 504 of the UE within the current paging cycle 506. On the other hand, if no PEI has been sent at the PEI-O 502 (e.g., due to no need to page any UEs up to the time of the PEI-O 502) or the PEI sent at the PEI-O 502 doesn't indicate the subgroup of the UE (e.g., due to none of the UEs to be paged, up to the time of the PEI-O 502, shares the same PO and the same subgroup with the UE), the gNB needs to postpone paging the UE until a next paging cycle (e.g., paging cycle 508 in FIG. 5), because the UE may not monitor its PO 504 within the current paging cycle 506. In the later situation, the paging queuing delay is increased by one paging cycle comparing to the case where paging the UE is done in accordance with the conventional paging procedure (i.e., without the use of PEI).

Assuming the durations of the PO and the PEI-O are negligible comparing to the durations of the paging cycle or the time interval between the PEI-O and the PO of the UE, the average paging queuing delay is increased, due to the use of PEI, by an amount approximately equal to the duration of the time interval between the PEI-O and the PO, which is 10, 30, or 50 msec depending on the configuration of the PEI-O location relative to the PO location, multiplied by the probability (P) that no PEI is sent at the PEI-O or the PEI sent at the PEI-O doesn't indicate the subgroup of the UE, where P may approximate to 1 in a network where the paging load is light or the use of UE subgrouping has separated UEs very well (e.g., separating the second UE from the UE in subgrouping). Hence, comparing to the average paging queuing delay (ranging from 5 to 5120 msec) in the conventional paging procedure, an additional paging queuing delay of roughly 10, 30, or 50 msec, due to the use of PEI, may be significant when the paging DRX cycle configured is relatively short.

Some mission-critical data services, such as those used in smart-grid, industrial IoT and remote control, push-to-talk, and data or positioning services for emergency call or emergency personnel, may not be able to tolerate a long paging delay, which includes the paging queuing delay in paging a UE and the delay for the UE responding to the paging (such as sending a PRACH and establishing or resuming a connection with the gNB). For these services, increasing the paging queuing delay by 10, 30, or 50 msec due to the use of PEI in paging the UE may not be acceptable. Therefore, the network needs to be able to control (i.e., enable or disable) the use of PEI in paging a UE based on whether the service(s) running on the UE can tolerate the additional 10, 30, or 50 msec of paging queuing delay due to the use of PEI in paging the UE.

Currently, there is no means for the network to enable or disable the use of PEI on an individual UE's basis. Although the gNB can disable the use of PEI in a cell by broadcasting the SI without any configuration information related to PEI, that will disable the use of PEI for all idle or inactive UEs in the cell. So is the case if the gNB wishes to disable the use of UEID-based subgrouping. Although the CN can disable the use of CN-assigned subgrouping for a UE by not assigning a CN-assigned subgroup ID to the UE, according to the existing agreements, the gNB and the UE will still use PEI with UEID-based subgrouping in transmitting or receiving the paging message for the UE, as long as both the gNB and the UE are capable of supporting UEID-based subgrouping. Therefore, a mechanism for the network to control (i.e., enable or disable) the use of PEI on an individual UE's basis is needed so that the use of PEI can be disabled for an individual UE, e.g., a UE having a stringent paging delay requirement, should the network determine that the delay requirement may be violated if PEI is used in paging the UE.

Aspects of the present disclosure provide means for a network node to decide whether to enable or disable the use of PEI in paging a UE on an individual UE's basis including but not limited to a delay requirement of a service running on the UE, a service type of a service running on the UE, a UE type of the UE, and a request received from the UE, etc.

Aspects of the present disclosure further provide signaling mechanisms between the network node and a gNB for configuring the gNB with regards to whether the gNB transmits a PEI indicating a subgroup associated with the UE during a PEI-O of the UE before transmitting the paging DCI and paging message for the UE during a PO of the UE, and provide signaling mechanisms between the network node and the UE and/or between the serving gNB of UE and the UE, for configuring the UE with regards to whether the UE needs to receive the PEI indicating the subgroup associated with the UE during the PEI-O of the UE before the UE is required to receive the paging DCI and paging message during the PO of the UE.

The present disclosure provides methods for the network to control (i.e., enable or disable) the use of PEI in paging a UE in the RRC_IDLE or RRC_INACTIVE state on an individual UE's basis. The methods provide means for a network node to decide (or update its decision on) whether to enable or disable the use of PEI in paging the UE and means for the network node to convey its decision (or update thereof) on whether to enable or disable the use of PEI in paging the UE to gNBs participating in paging the UE and to the UE. The methods also provide means for a first gNB, after receiving the network node's decision on whether to enable or disable the use of PEI in paging the UE, to forward the network node's decision to a second gNB due to a need to handover the UE to the second gNB while the UE is still in RRC_CONNECTED state or due to a need to request the second gNB to send an RAN-initiated paging message to the UE after the UE has entered the RRC_INACTIVE state. When a paging message for the UE arrives at or is generated by the gNB, the gNB determines, in accordance with the network node's decision received, whether to transmit a PEI indicating a subgroup associated with the UE during a PEI-O of the UE before transmitting the paging DCI and the paging message for the UE during a PO of the UE. After entering the RRC_IDLE or RRC_INACTIVE state, the UE determines, in accordance with the network node's decision received, whether to monitor PEI before determining a need for monitoring a subsequent paging DCI and paging message.

### Network Entity and Means for Deciding Whether to Enable or Disable the Use of PEI in Paging a UE

In accordance with various embodiments, a serving AMF of a UE may be a network entity for deciding (or updating a previous decision on) whether to enable or disable the use of PEI in paging the UE.

In some embodiments, an AMF's decision to enable or disable the use of PEI in paging a UE may be made individually based on a delay requirement of the UE, e.g., the delay requirement being derived from the most stringent delay requirement among the QoS flow(s) of the data PDU session(s) established on the UE. Therefore, the decision (to enable or disable) may be made or updated whenever a data PDU session is established or modified on the UE or released from the UE. During a PDU session setup, modification, or release procedure, the AMF may obtain QoS information of the QoS flow(s) of the data PDU session from a session management function (SMF) serving the data PDU session to be established, modified, or released. Then, based on the QoS information of the data PDU sessions (remaining) on the UE, the AMF may determine the delay requirement of the UE. Meanwhile, each of the gNBs served by the AMF may provide the AMF with RAN assistance information regarding the time interval between the PEI-O and target PO configured by the gNB for each cell served by the gNB. An average or an upper bound value of the time intervals between the PEI-Os and target POs configured by the gNB may be provided to the AMF. The AMF may use 50 msec (i.e., the upper bound value) or the longest one among the time interval values provided by the gNBs within the registration area of the UE as the additional paging queuing delay due to the use of PEI in determining whether adding the additional paging queuing may cause the delay requirement of the UE to be violated, and based thereon, the AMF may decide whether to enable or disable the use of PEI in paging the UE. For example, if the additional paging queuing delay due to the use of PEI would cause the delay requirement of the UE to be violated, the AMF may decide to disable the use of PEI in paging the UE; otherwise, if the delay requirement of the UE can be met despite the additional paging queuing delay due to the use of PEI, the AMF may decide to enable the use of PEI in paging the UE.

In some other embodiments, the AMF's decision to enable or disable the use of PEI in paging a UE may be made individually based on a service type of a service running the UE. For example, when a PDU session is being established on the UE for an emergency call or emergency data service (the PDU session being referred to as an emergency PDU session) or a mission critical service (the PDU session being referred to as a mission critical PDU session), the PEI function may be disabled (or suspended) on the UE, and when the emergency PDU session or the mission-critical PDU session is released from the UE, the PEI function may be enabled (or resumed) on the UE.

In yet some other embodiments, the AMF's decision to enable or disable the use of PEI in paging a UE may be made individually based on a UE type of the UE, e.g., the UE type indicating that the UE is used by a first responder or another emergency personnel.

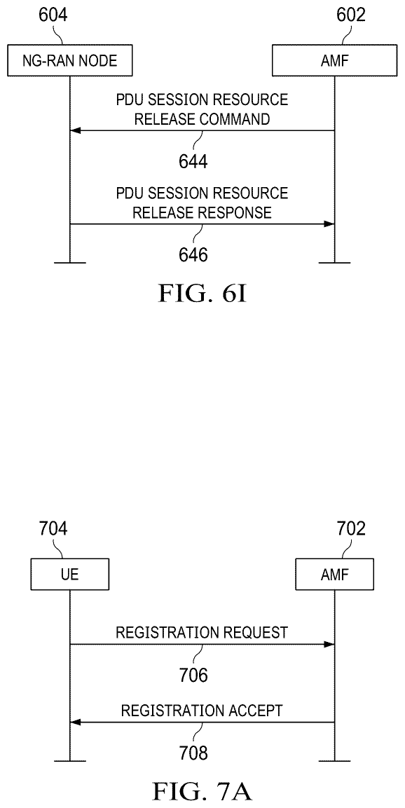

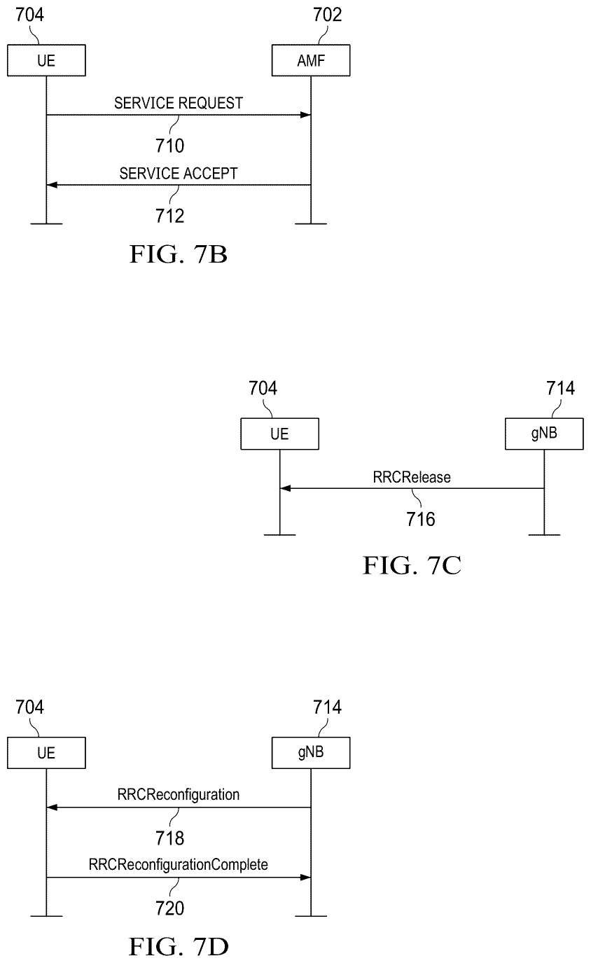

In yet some other embodiments, the AMF's decision to enable or disable the use of PEI in paging a UE may be made individually based on a request received from the UE. The UE may request the network to enable or disable the use of PEI for paging the UE via a dedicated NAS signaling sent from the UE to the AMF. For example, the UE may include a request to disable the use of PEI in a REGISTRATION REQUEST message sent to the AMF during a registration request procedure (such as REGISTRATION REQUEST message 706 illustrated in FIG. 7A) when the request is triggered by a specific UE type of the UE. For another example, the UE may include a request to enable (or disable) the use of PEI in a SERVICE REQUEST message sent to the AMF during a service request procedure (such as SERVICE REQUEST message 710 illustrated in FIG. 7B) when the request is triggered by a QoS requirement of a service being requested. For yet another example, the UE may implicitly request to disable the use of PEI in a REGISTRATION REQUEST message sent to the AMF (e.g., REGISTRATION REQUEST message 706 illustrated in FIG. 7A) or a SERVICE REQUEST message sent to the AMF (e.g., SERVICE REQUEST message 710 illustrated in FIG. 7B) when an RRC Establishment Cause IE or an Request Type IE in the message sent indicates that the UE is requesting an emergency service or a mission critical service. For yet another example, the UE may implicitly request to enable the use of PEI in the REGISTRATION REQUEST message 706 or the SERVICE REQUEST message 710 sent to the AMF when the RRC Establishment Cause IE and the Request Type IE in the message sent indicate that the UE is requesting a service that is neither an emergency service nor a mission critical service.

The AMF's decision to enable or disable the use of PEI in paging a UE may be conveyed to the UE and the gNB(s) through a new information element (IE) in a signaling message. For example, the new IE may be referred to as a PEI Enabled IE (or Paging With PEI IE). The PEI Enabled IE may carry either a value representing True or another value representing False, the True value indicating that the use of PEI is enabled and the False value indicating that use of PEI is disabled. Alternatively, the PEI Enabled IE, if present in the message, may carry a value representing True, the True value indicating that the use of PEI is enabled, while an absence of the PEI Enabled IE in the message indicates that the use of PEI is disabled. For another example, the new IE may be referred to as a PEI Disabled IE (or Paging Without PEI IE). The PEI Disabled IE may carry either a value representing True or another value representing False, the True value indicating that the use of PEI is disabled and the False value indicating that use of PEI is enabled. Alternatively, the PEI Disabled IE, if present in the message, may carry a value representing True, the True value indicating that the use of PEI is disabled, while an absence of the PEI Disabled IE in the message may indicate that the use of PEI is enabled.

In some other embodiments, the decision to disable (or suspend) the use of PEI in paging a UE may be implicitly conveyed to the UE through an NAS signaling message that is sent from the AMF to the UE to accept the UE's request for establishing an emergency PDU session or mission critical session on the UE, and the decision to enable (or resume) the use of PEI in paging the UE may be implicitly conveyed to the UE through another NAS signaling message that is sent from the AMF to the UE to release the emergency PDU session or the mission critical session from the UE.

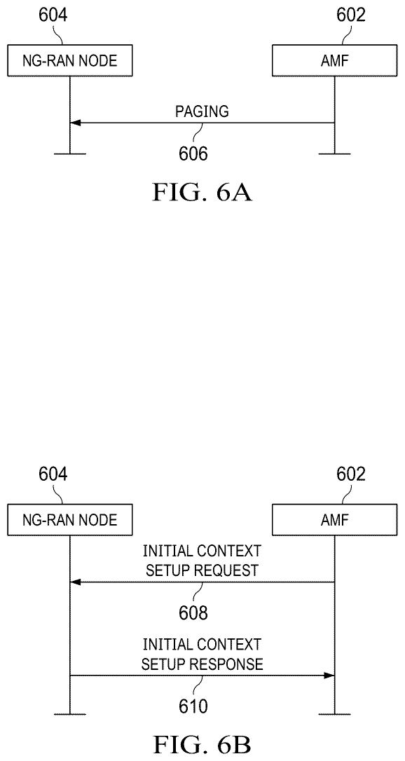

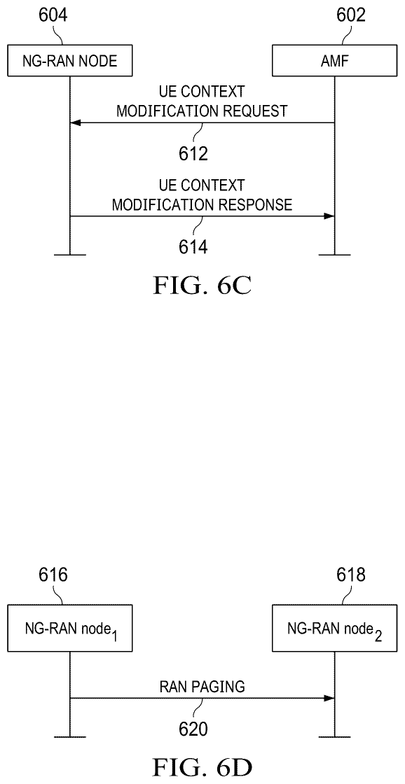

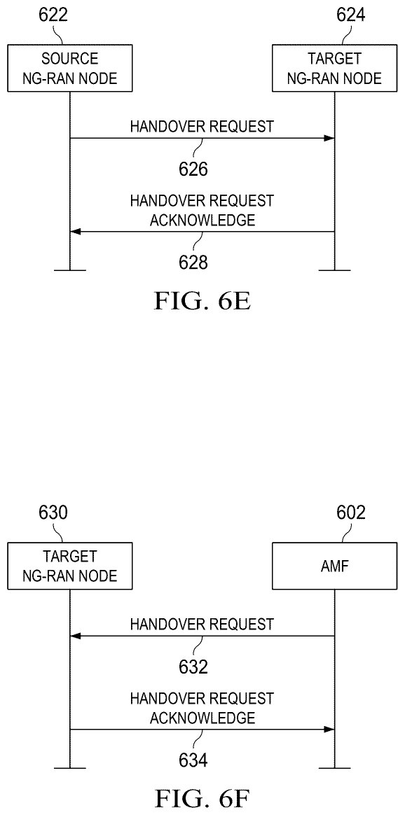

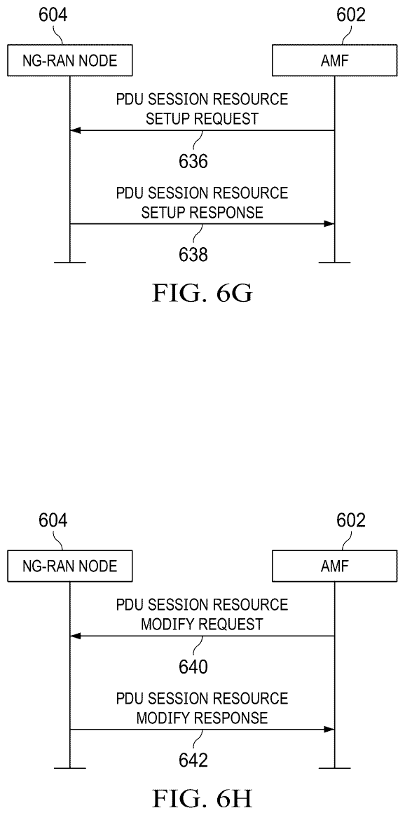

In yet some other embodiments, the decision to disable (or suspend) the use of PEI in paging a UE may be implicitly conveyed to the serving gNB of the UE through a signaling message sent from the AMF to the gNB (e.g., the Initial UE Context Setup Request message 608 illustrated in FIG. 6B or the UE Context Modification Request message 612 illustrated in FIG. 6C) by including, in the message, an Emergency Fallback Indicator IE indicating an emergency service fallback for the UE, and the decision to enable (or resume) the use of PEI in paging the UE may be implicitly conveyed to the serving gNB of the UE through the signaling message sent from the AMF to the gNB (e.g., the Initial UE Context Setup Request message 608 or the UE Context Modification Request message 612), without including the emergency fallback indicator IE in the message.

In various embodiments described herein, we may use the PEI Enabled IE as the example new IE for conveying the AMF's decision on whether to enable or disable the use of PEI in paging a UE to the gNB(s) and/or to the UE. The use of the PEI Disabled IE, as described above, in place of the PEI Enabled IE, is also possible for these embodiments. In some embodiments, conveying, including, or receiving an IE in a specific message doesn't necessarily means that the IE is physically included or received in the message, because in at least two out of the four example variants of the new IE described above, the absence of the new IE in the message may also indicate one of the two possible outcomes of the AMF's decision on whether to enable or disable the use of PEI. Therefore, all four example variants of the new IE, as described above, are possible for the various embodiments. A different name for the new IE or a different way of encoding the value of the new IE in each of the messages carrying the new IE may also be used. Other IEs (or the absence thereof), such as the Emergency Fallback Indicator IE described before, may also implicitly convey the decision to enable or disable the use of PEI for the UE in the various embodiments.

### Means for Conveying an AMF's Decision to gNB(s)

An AMF may configure gNB(s) with its decision on whether to enable or disable the use of PEI in paging a UE by conveying a PEI Enabled IE associated with the UE to the gNB(s) in a number of ways. FIGS. 6A-C and 6F-I illustrate various message sequence charts showing communications between an AMF and one or more RAN nodes according to some embodiments. FIGS. 6D-E illustrate various message sequence charts showing communications between a first RAN node and a second (neighboring) RAN node, where the first RAN node, after receiving the AMF's decision, conveys the AMF's decision to the second RAN node, according to some embodiments.

The present disclosure may describe or illustrate an embodiment message sequence chart that shows communications between an AMF and one or more next generation radio access network (NG-RAN) nodes. Such description is not intended to be construed in a limiting sense. In various embodiments, persons skilled in the art apply or implement the embodiment message sequence chart to any suitable RAN nodes known in the art (such as one or more gNBs). The term NG-RAN node, RAN node, and gNB may be used interchangeably in the present disclosure.

In various embodiments, an AMF may convey a PEI Enabled IE to one or more gNBs located within a registration area of a UE during a paging procedure. FIG. 6A illustrates that a PEI Enabled IE may be included in a PAGING message 606 sent from an AMF 602 to a next generation radio access network (NG-RAN) node 604. The PEI Enabled IE may be included as a part of a Paging Priority IE in the PAGING message 606 or as an IE independent from the Paging Priority IE in the PAGING message 606. The message sequence chart in FIG. 6A may occur when the AMF 602 forwards a CN-initiated paging message for the UE to the one or more gNBs requesting them to page the UE. This is one way for a non-serving gNB of the UE to know whether to use PEI in paging the UE or not, after the UE has already entered an RRC_IDLE or RRC_INACTIVE state.

In various embodiments, an AMF may convey a PEI Enabled IE to a serving gNB of a UE during UE context management procedures, while the UE is still in the RRC_CONNECTED state. For example, FIG. 6B illustrates that the AMF 602 may include the PEI Enabled IE, either as a part of a radio access network (RAN) Paging Priority IE or as an IE independent from the RAN Paging Priority IE, in an INITIAL CONTEXT SETUP REQUEST message 608 sent from the AMF 602 to the NG-RAN node 604 (as the serving gNB) during an initial context setup procedure. In another example, FIG. 6C illustrates that the AMF 602 may include the PEI Enabled IE, either as a part of a RAN Paging Priority IE or as an IE independent from the RAN Paging Priority IE, in a UE CONTEXT MODIFICATION REQUEST message 612 sent from the AMF 602 to the NG-RAN node 604 (as the serving gNB) during a UE context modification procedure. In yet another example, the AMF 602 may include an Emergency Fallback Indicator IE in the INITIAL CONTEXT SETUP REQUEST message 608 or the UE CONTEXT MODIFICATION REQUEST message 612 sent to the NG-RAN node 604 to indicate that the UE is about to fall back to an emergency service and thereby to implicitly indicate to the NG-RAN node 604 to disable the use of PEI for the UE.

In various embodiments, the serving gNB may store the PEI Enabled IE in the UE context associated with the UE. Upon releasing the UE into the RRC_IDLE or RRC_INACTIVE state, the serving gNB may become the last serving gNB (which is also referred as an anchor gNB) of the UE. Later, when a need to page the UE arises at the anchor gNB (e.g., an RAN-initiated paging), the anchor gNB may page the UE in accordance with the PEI Enabled IE stored in the UE context associated with the UE. The anchor gNB may further configure one or more of its neighboring gNBs with the AMF's decision on whether to enable or disable the use of PEI in paging the UE. FIG. 6D illustrates that an anchor gNB 616 (which is denoted as NG-RAN node₁ in FIG. 6D) may include the stored PEI Enabled IE in a RAN PAGING message 620 sent from the anchor gNB 616 to its neighboring gNB 618 (which is denoted as NG-RAN node₂ in FIG. 6D), when the anchor gNB 616 requests the neighboring gNB 618 to participate in the effort of paging the UE.

In various embodiments, the serving gNB (acting as a source gNB) may also convey the stored PEI Enabled IE to a target gNB of the UE during an Xn-interface-based UE handover procedure, which procedure hands over the UE from the source gNB to the target gNB with the source gNB and the target gNB communicating with one another directly without involving the AMF. FIG. 6E illustrates that a source gNB 622 (also referred to as a source NG-RAN node), may include the PEI Enabled IE in a HANDOVER REQUEST message 626 sent from the source gNB 622 to a target gNB 624 (also referred to as a target NG-RAN node). Upon the completion of a successful handover of the UE, the target gNB 624 may become a new serving gNB of the UE and store the PEI Enabled IE in the UE context associated the UE. Then the target gNB 624 may forward the stored PEI Enabled IE to a new target gNB during a subsequent Xn-interface-based handover of the UE (while the UE is still in the RRC_CONNECTED state) or to a neighboring gNB when requesting the neighboring gNB to participate in the effort of paging the UE (after the UE is released into the RRC_IDLE or RRC_INACTIVE state), as described above.

In various embodiments, an AMF may convey a PEI Enabled IE to a target gNB of a UE during an NG-interface-based UE handover procedure, which procedure hands over the UE from the source gNB to the target gNB with the source gNB and the target gNB communicating with one another indirectly through the AMF. FIG. 6F illustrates that the AMF 602 may include a PEI Enabled IE in a HANDOVER REQUEST message 632 sent from the AMF 602 to a target gNB 630 (also referred to as a target NG-RAN node). Upon the completion of a successful handover of the UE, the target gNB 630 may become a new serving gNB of the UE and store the PEI Enabled IE in the UE context associated with the UE. Then the target gNB 630 may forward the stored PEI Enabled IE to a new target gNB or to a neighboring gNB, as described above.

In various embodiments, the AMF may change its decision regarding whether to enable or disable the use of PEI in paging a UE as a result of a data PDU session (e.g., an emergency PDU session or mission critical PDU session) being established or modified on the UE or released from the UE. The AMF may convey its updated decision to the serving gNB of the UE by including the PEI Enable IE or the Emergency Fallback Indicator IE in the UE CONTEXT MODIFICATION REQUEST message 612 sent from the AMF to the gNB, as illustrated in FIG. 6C and described before. Alternatively, the AMF may convey its updated decision to the serving gNB of the UE without a need for initiating a separate UE context management procedure as described above. FIG. 6G illustrates that the AMF 602 includes an updated PEI Enabled IE in a PDU SESSION RESOURCE SETUP REQUEST message 636 sent from the AMF 602 to the NG-RAN node 604 (as a serving gNB) during a PDU session setup procedure. FIG. 6H illustrates that the AMF 602 includes an updated PEI Enabled IE in a PDU SESSION RESOURCE MODIFY REQUEST message 640 sent from the AMF 602 to the NG-RAN node 604 (as a serving gNB) during a PDU session modification procedure. FIG. 6I illustrates that the AMF 602 includes an updated PEI Enabled IE in a PDU SESSION RESOURCE RELEASE COMMAND message 644 sent from the AMF 602 to the NG-RAN node 604 (as a serving gNB) during a PDU session release procedure.

### Means for Conveying an AMF's Decision to a UE

In various embodiments, an AMF may configure a UE with its decision on whether to enable or disable the use of PEI in paging the UE, e.g., by including the PEI Enabled IE in a dedicated NAS signaling sent from the AMF to the UE. Examples of the dedicated NAS signaling may include a REGISTRATION ACCEPT message and a SERVICE ACCEPT message. FIG. 7A illustrates that an AMF 702 includes a PEI Enabled IE in a REGISTRATION ACCEPT message 708 sent from the AMF 702 to a UE 704 during a registration request procedure. FIG. 7B illustrates that the AMF 702 includes a PEI Enabled IE in a SERVICE ACCEPT message 712 sent from the AMF 702 to the UE 704 during a service request procedure. As previously described, the UE 704 may have included a request to enable or disable the use of PEI in a REGISTRATION REQUEST message 706 (as shown in FIG. 7A) or a SERVICE REQUEST message 710 (as shown in FIG. 7B) sent from the UE 704 to the AMF 702. However, the final decision to enable or disable the use of PEI in paging the UE 704 may be still for the AMF 702 to make. If the UE 704's request (to enable or disable the use of PEI) isn't granted by the AMF 702, the UE 704 may use the final decision made by the AMF 702 in determining whether there is a need to monitor the PEI before monitoring paging PCI and its paging message while in the RRC_IDLE or RRC_INACTIVE state, or the UE 704 may leave the network to select another network to be served. If the UE 704's request (to enable or disable the use of PEI) isn't granted due to a mis-match with the AMF 702's capability regarding enabling or disabling the use of PEI, the UE 704 may use a registration update procedure to cause a different (and capable) AMF to be selected as the serving AMF of the UE 704.

In various embodiments, an AMF's decision on whether to enable or disable the use of PEI in paging a UE is conveyed to the UE by a serving gNB of the UE via a dedicated RRC signaling, which is sent from the serving gNB to the UE.

FIG. 7C illustrates that a gNB 714 (as a serving gNB of a UE 704) transmits a RRCRelease message 716 to the UE 704, as an example of the serving gNB conveying the decision to the UE. The serving gNB 714, after receiving the PEI Enabled IE associated with the UE 704 from a serving AMF of the UE 704 (or from a source gNB during a handover of the UE 704), may store the PEI Enabled IE in the UE context associated with the UE 704. Then, when it is time to release the UE 704 into the RRC_IDLE or RRC_INACTIVE state, the serving gNB 714 may include the PEI Enabled IE in the RRCRelease message 716 sent from the serving gNB 714 to the UE 704. The UE 704 may use the PEI Enabled IE received in the RRCRelease message 716 to determine whether there is a need to monitor the PEI before monitoring paging PCI and paging message while in the RRC_IDLE or RRC_INACTIVE state.

FIG. 7D illustrates an RRC reconfiguration procedure between the gNB/serving gNB 714 and the UE 704, as an alternative example of the serving gNB conveying the decision to the UE. The gNB 714 of the UE 704, after receiving the PEI Enabled IE associated with the UE 704 from the serving AMF of the UE 704 (or from a source gNB during a handover of the UE 704), determines whether to configure any PEI-O for the UE 704 during an RRC reconfiguration procedure based on the PEI Enable IE received. If the PEI Enable IE received indicates that PEI is to be used in paging the UE 704, the gNB 714 may include PEI-O location information in an RRCReconfiguration message 718 sent from the gNB 714 to the UE 704. Otherwise, the gNB 714 may include no PEI-O configuration information in the RRCReconfiguration message 718. In the former situation, the UE 704 has a PEI-O to monitor and therefore is implicitly informed that PEI is to be used in paging the UE 704, hence the UE 704 will monitor the PEI before determining whether to monitor paging DCI and paging message. In the latter situation, the UE 704 has no PEI-O to monitor and therefore is implicitly informed that PEI is not to be used in paging the UE 704, hence the UE 704 will monitor paging DCI and paging message without a need for monitoring the PEI first.

### UE's Behaviors While in the RRC_IDLE or RRC_INACTIVE State

After entering the RRC_IDLE or RRC_INACTIVE state, a UE may first determine whether the use of PEI in paging the UE has been enabled or disabled by a serving AMF of the UE, in accordance with a PEI Enabled IE received from the serving AMF or from the last serving gNB of the UE prior to being released into the RRC_IDLE or RRC_INACTIVE state. In response to determining that the use of PEI in paging the UE has been disabled by the AMF, the UE may monitor its paging message in the conventional way (i.e., without a need for monitoring the PEI first, throughout the cells in the registration area of the UE). In response to determining that the use of PEI in paging the UE has been enabled by the AMF, the UE may further determine whether the use of PEI is supported in a cell that the UE currently camps in, based on the SI broadcasted by the gNB serving the cell. For example, if valid PEI configuration information is included in the SI, the use of PEI is supported in the cell; otherwise, the use of PEI isn't supported in the cell. Then, in response to determining that the use of PEI isn't supported in the cell that the UE currently camps in, the UE may monitor its paging message in the conventional way while camping in the cell. In response to determining that the use of PEI in paging the UE has been enabled by the AMF and that the use of PEI is supported in the cell that the UE currently camps in, the UE may further determine a subgroup ID associated with the UE. Therefore, the UE may determine its subgroup ID only if the UE determines that PEI is to be used in paging the UE in the cell that the UE currently camps in.

The UE may determine its subgrouping ID based on whether the UE has a CN-assigned subgroup ID and whether the CN-assigned subgrouping method and/or the UEID-based subgrouping method are supported in the cell.

The support (or non-support) of UEID-based subgrouping in a cell may be implicitly indicated by a parameter referred to as subgroupsNumforUEID (or N_{sg-UEID}) and broadcasted in the SI by the gNB serving the cell. The parameter subgroupsNumforUEID may indicate the number of subgroups configured for each PO for the UEID-based subgrouping method. For example, the presence of subgroupsNumforUEID in the SI (with a value greater than o) may indicate that the UEID-based subgrouping is supported in the cell, while the absence of subgroupsNumforUEID in the SI may indicate that the UEID-based subgrouping isn't supported in the cell. As another example, subgroupsNumforUEID may be present in the SI as long as one of the two subgrouping methods is supported in the cell, and a subgroupsNumforUEID value greater than 1 may indicate that the UEID-based subgrouping is supported in the cell while a subgroupsNumforUEID value equal to o may indicate that the UEID-based subgrouping isn't supported in the cell.

The support (or non-support) of CN-assigned subgrouping in a cell may be implicitly indicated by the parameter subgroupsNumforUEID and another parameter, which is referred to as subgroupsNumPerPO (or N_{sg}) and also broadcasted in the SI by the gNB serving the cell. The parameter subgroupsNumPerPO may indicate the total number of subgroups configured for each PO. For example, if both parameters are present in the SI and have a same value (i.e., the value of subgroupsNumPerPO equals to the value of subgroupsNumforUEID), the CN-assigned subgrouping method isn't supported in the cell; otherwise, if both parameters are present in the SI and the value of subgroupsNumPerPO is greater than the value of subgroupsNumforUEID or if subgroupsNumPerPO is present but subgroupsNumforUEID is absent in the SI, the CN-assigned subgrouping method is supported in the cell.

In response to determining that the UE has a CN-assigned subgroup ID and that the CN-assigned subgrouping method is supported in the cell, the UE may use the CN-assigned subgroup ID as its subgroup ID for the PEI to be monitored while camping in the cell. On the other hand, in response to determining that the UE doesn't have a CN-assigned subgroup ID or that the CN-assigned subgrouping method isn't supported in the cell but the UEID-based subgrouping method is supported in the cell that the UE currently camps in, the UE may derive its subgroup ID for the PEI to be monitored while camping in the cell, as follows:
the subgroup ID=floor(UEID/(N*Ns)) mod subgroupsNumforUEID, if subgroupsNumforUEID is absent in the SI; and
the subgroup ID=(subgroupsNumPerPO−subgroupsNumforUEID)+(floor(UEID/(N*Ns)) mod subgroupsNumforUEID), if subgroupsNumforUEID is present in the SI,
where N is the total number of paging frames configured within each DRX cycle of the UE, Ns is the number of POs configured within each of the paging frames, floor( ) represents the floor function, which produces the greatest integer less than or equal to an input value inside the ( ), and mod represents the modulo function of A mod B, which produces the reminder of a division after dividing A by B.

Then, while in the RRC_IDLE or RRC_INACTIVE state, the UE may monitor its PEI-O in each DRX cycle for a PEI indicating that its subgroup is being paged (e.g., the subgroup ID of the UE being indicated in the PEI) or a bit in a bitmap carried in the PEI being set to a value indicating the paging, the position of the bit in the bitmap corresponding to the subgroup ID of the UE. When the PEI is received, the UE may further monitor its PO for a paging DCI, use scheduling information in the paging DCI to decode PDSCH to retrieve a paging message, and determine whether the UE is actually being paged in accordance with the paging message retrieved (i.e., whether the paging message indicates the UEID of the UE). When the PEI isn't received, the UE may return to a deep sleep mode until a time to wake up for monitoring the PEI-O in the next DRX cycle, without a need for monitoring its PO for paging DCI or paging message during the current DRX cycle.

### Operation Flow of an AMF

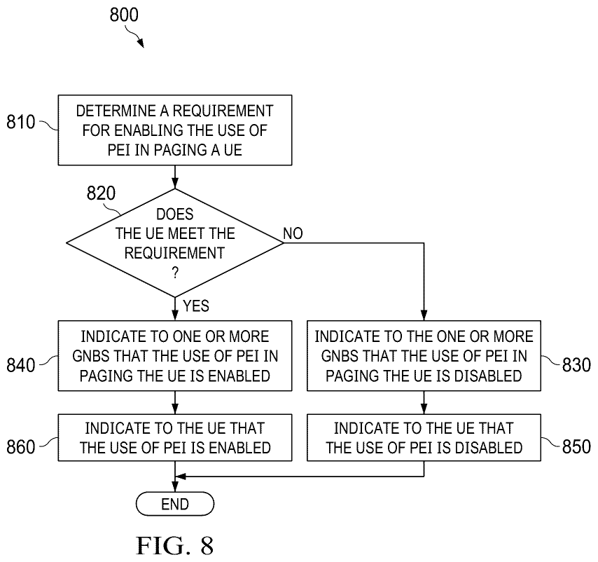

FIG. 8 illustrates a flow chart of operations 800 occurring in an AMF according to some embodiments. Operations 800 may be indicative of operations occurring in an AMF, as the AMF serves as the serving AMF of a UE and prepares gNB(s) for paging the UE.

Operations 800 may begin with the AMF determining a requirement for enabling the use of PEI in paging the UE (step 810). For example, the requirement may be a delay requirement that all data PDU sessions established on the UE must be able to satisfy, assuming there is an additional paging queuing delay due to the use of PEI in paging, in order to enable the use of PEI in paging the UE. Alternatively, or in addition to the requirement for enabling, the AMF may determine a requirement for disabling the use of PEI in paging the UE. For example, the requirement may be a specific UE type, where upon the UE indicating that it is the specific type of UE (e.g., the UE being used by a first responder or other emergency personnel), the use of PEI in paging the UE is to be disabled. For another example, the requirement for the disabling may be an emergency service running on the UE, where upon the establishment of an emergency PDU session for the emergency service, the use of PEI in paging the UE is to be disabled. The AMF may receive RAN assistance information from gNBs served by the AMF, the RAN assistance information provides an estimation of the additional paging queuing delay due to the use of PEI in paging.

Then, the AMF may determine whether the UE meets the requirement (step 820). For example, if all data PDU sessions established on the UE can satisfy the delay requirement, assuming there is the additional paging queuing delay due to the use of PEI in paging, the AMF determines that the requirement (to enable) is met by the UE; otherwise, the requirement (to enable) is not met by the UE. As another example, if the UE indicates that it is the specific type of UE or the UE requests an emergency service, the AMF determines that the requirement (to disable) is met by the UE; otherwise, the requirement (to disable) is not met by the UE.

In response to determining that the requirement to enable is not met (or that the requirement to disable is met) in step 820, the AMF may decide to disable the use of PEI in paging the UE and indicates its decision to one or more gNBs (step 830). For example, the AMF may indicate its decision to the serving gNB of the UE during a UE context management (initial context setup or context modification) procedure or a PDU session management (setup, modification, or release) procedure, or to a target gNB during an NG-interface-based handover procedure, while the UE is still in the RRC_CONNECTED state, as illustrated in FIGS. 6B, 6C, 6G, 6H, 6I, and 6F, respectively, and as described before. As another example, the AMF may indicate its decision to one or more gNBs within the registration area of the UE when requesting the one or more gNBs to page the UE during a paging procedure, as illustrated in FIG. 6A and described before, the UE being in the RRC_IDLE or RRC_INACTIVE state already. Optionally, the AMF may further indicate its decision to disable the use of PEI in paging the UE to the UE while the UE is still in the RRC_CONNECTED state (step 850). For example, the AMF's decision (to disable) is conveyed via a dedicated NAS signal, such as a REGISTRATION ACCEPT or SERVICE ACCEPT message sent from the AMF to the UE during a registration request or service request procedure, as illustrated in FIGS. 7A and 7B, respectively, and as described before. Then, operations 800 may end.

On the other hand, in response to determining that the requirement to enable is met (or that the requirement to disable is not met) in step 820, the AMF may decide to enable the use of PEI in paging the UE and indicates its decision to the one or more gNBs (step 840). For examples, the AMF may indicate its decision to the serving gNB of the UE during a UE context management procedure or a PDU session management procedure, to a target gNB during an NG-interface-based handover procedure, or to one or more gNBs during a paging procedure, as illustrated in FIGS. 6B, 6C, 6G, 6H, 6I, 6F, and 6A, respectively, and as described before. Optionally, the AMF may further indicate its decision to enable the use of PEI in paging the UE to the UE while the UE is still in the RRC_CONNECTED state (step 860). For examples, the AMF's decision (to enable) is conveyed via a dedicated NAS signal, such as the REGISTRATION ACCEPT or SERVICE ACCEPT message sent from the AMF to the UE during the registration request or service request procedure, as illustrated in FIGS. 7A and 7B, respectively, and as described before. Then, operations 800 may end.

### Operation Flow of a gNB

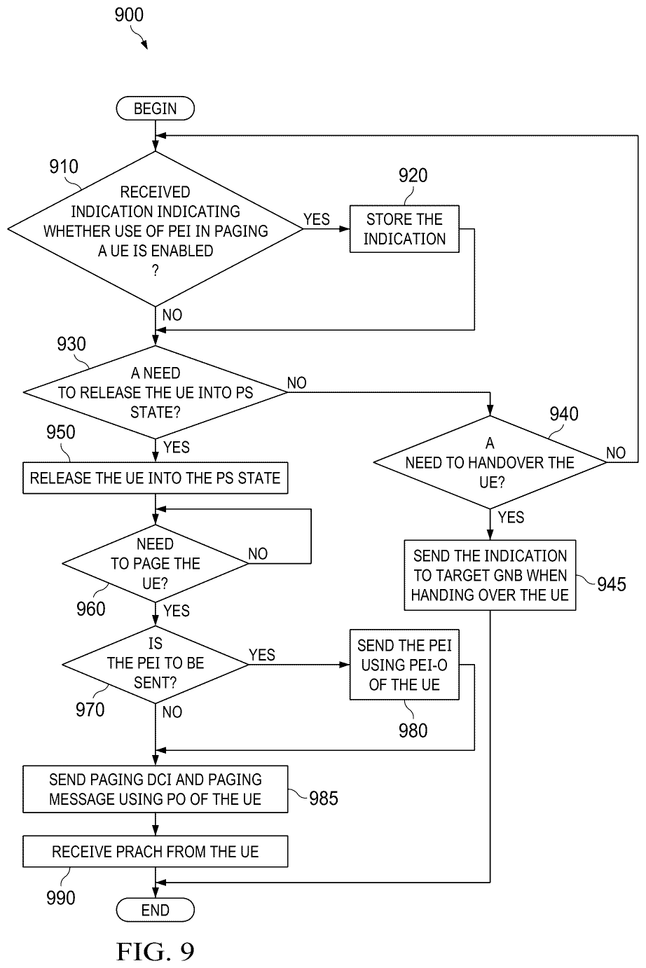

FIG. 9 illustrates a flow chart of operations 900 occurring in a gNB according to some embodiments. Operations 900 may be indicative of operations occurring in a gNB, as the gNB serves as the serving gNB of a UE and prepares for paging the UE when the UE enters an RRC_IDLE or RRC_INACTIVE state.

Operations 900 may begin with the gNB determining whether an indication is received, the indication indicating whether the use of PEI in paging the UE is enabled or disabled (Step 910). For example, the gNB may determine whether the indication is received from a serving AMF of the UE during a UE context management procedure, a PDU session management (setup, modification, and release) procedure, or an NG-interface-based handover procedure, as illustrated in FIGS. 6B, 6C, 6G, 6H, 6I, and 6F, respectively, and as described before. As another example, the gNB may determine whether the indication is received from a previous serving gNB of the UE during an Xn-interface-based handover procedure, the previously gNB acting as the source gNB and the gNB acting as the target gNB during the handover procedure, as illustrated in FIG. 6E and described before. The indication may be indicated in one of the four variants of the new IE referred to as the PEI Enabled IE or PEI Disable IE, as described before. In response to determining that the indication is received in step 910, the gNB may store the indication in the UE context associated with the UE (step 920).

The gNB may further determine whether there is a need to release the UE into a power saving (PS) state, the PS state being either the RRC_IDLE state or the RRC_INACTIVE state (step 930). In response to determining that there is no need to release the UE into either the RRC_IDLE state or the RRC_INACTIVE state, the gNB may further determine whether there is a need to handover the UE to a target gNB (step 940). In response to determining that there is no need to handover the UE, the gNB may go back to step 910. In response to determining that there is a need to handover the UE to the target gNB, the gNB may send the stored indication to the target gNB during the handover of the UE (step 945). For example, the gNB may include the PEI Enabled IE in the HANDOVER REQUEST message sent to the target gNB, as illustrated in FIG. 6E, and described before. Upon the completion of the handover, the gNB may cease to be the serving gNB of the UE. Then, operations 900 may end.

On the other hand, in response to determining that there is a need to release the UE into the RRC_IDLE state or the RRC_INACTIVE state in step 930, the gNB may release the UE into the RRC_IDLE state or the RRC_INACTIVE state (step 950). For example, the gNB may send an RRCRelease message to the UE to release the UE into the RRC_IDLE state or the RRC_INACTIVE state. The gNB may include the stored indication (e.g., the PEI Enabled IE) in the RRCRelease message sent to the UE, as illustrated in FIG. 7C, and as described before. Then, the gNB may determine whether there is a need to page the UE (step 960). For example, the gNB may determine that there is a need to page the UE when an RAN-initiated paging message intended for the UE has been generated at the gNB or when a CN-initiated paging message intended for the UE has been received from the serving AMF of the UE. The gNB may continue to determine whether there is a need to page the UE until the need to page the UE is determined.

In response to determining that there is a need to page the UE in step 960, the gNB may further determine whether it needs to send a PEI before sending paging DCI and the paging message intended for the UE, the PEI indicating the subgroup of the UE (step 970). For example, if the stored indication indicates that the use of PEI in paging the UE is enabled and the gNB is capable of sending PEI, the gNB may determine that the PEI is to be sent before the paging DCI and the paging message intended for the UE. On the other hand, if the stored indication indicates that the use of PEI in paging the UE is disabled or the gNB is incapable of sending PEI, the gNB may determine that the PEI is not to be sent.

In response to determining that the PEI is not to be sent in step 970, the gNB may send paging DCI and the paging message intended for the UE using the PO of the UE (step 985). On the other hand, in response to determining that the PEI is to be sent in step 970, the gNB may send the PEI using the PEI-O of the UE first (step 980). Then, the gNB may send the paging DCI and the paging message intended for the UE using the PO of the UE in step 985. The gNB may receive a PRACH from the UE (step 990), and based thereon, operations 900 may end and the gNB may proceed with operations in a random access procedure to resume communications with the UE.

### Operation Flows of a UE

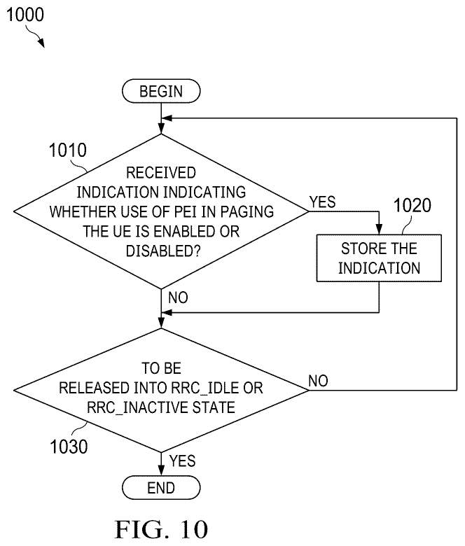

FIG. 10 illustrates a flow chart of operations 1000 occurring in a UE according to some embodiments. Operations 1000 may be indicative of operations occurring in a UE, as the UE, while in an RRC_CONNECTED state, receives signaling messages regarding whether the use of PEI in paging the UE is enabled or disabled.

Operations 1000 may begin with the UE determining whether an indication is received, the indication indicating whether the use of PEI in paging the UE is enabled or disabled (Step 1010). For example, the indication may be received from a serving AMF of the UE in a dedicated NAS signaling, such as a REGISTRATION ACCEPT message or a SERVICE ACCEPT message received from the AMF during the registration request procedure or the service request procedure, as illustrated in FIGS. 7A and 7B, respectively, and as described before. As another example, the indication may be received from the serving gNB of the UE in a dedicated RRC signaling, such as an RRCRelease message or an RRCReconfiguration message, as illustrated in FIGS. 7C and 7D, respectively, and as described before. The indication may be carried as the PEI Enabled IE or the PEI Disabled IE, as described before.

In response to determining that the indication is received in step 1010, the UE may store the indication in the UE context of the UE (step 1020). The UE may further determine whether it is to be released into an RRC_IDLE state or an RRC_INACTIVE state (step 1030). For example, the UE is to be released into the RRC_IDLE state or the RRC_INACTIVE state if the UE receives an RRCRelease message from its serving gNB; otherwise, the UE is not to be released into the RRC_IDLE state or the RRC_INACTIVE state. In response to determining that the UE is not to be released into the RRC_IDLE state or the RRC_INACTIVE state in step 1030, the UE may go back to step 1010. If the UE receives the indication again, the UE may update its stored indication with the newly received indication, for as long as the UE remains in the RRC_CONNECTED state. In response to determining that the UE is to be released into the RRC_IDLE state or the RRC_INACTIVE state in step 1030, the UE may enter the RRC_IDLE state or the RRC_INACTIVE state and operations 1000 may end.

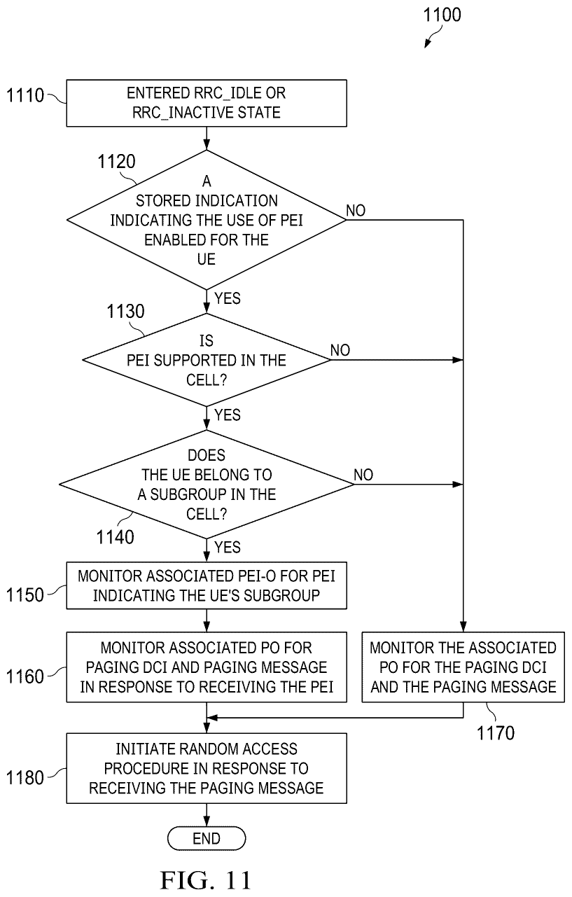

FIG. 11 illustrates a flow chart of operations 1100 occurring in a UE according to some embodiments. Operations 1100 may be indicative of operations occurring in a UE, as the UE receives its paging message after entering an RRC_IDLE state or an RRC_INACTIVE state.

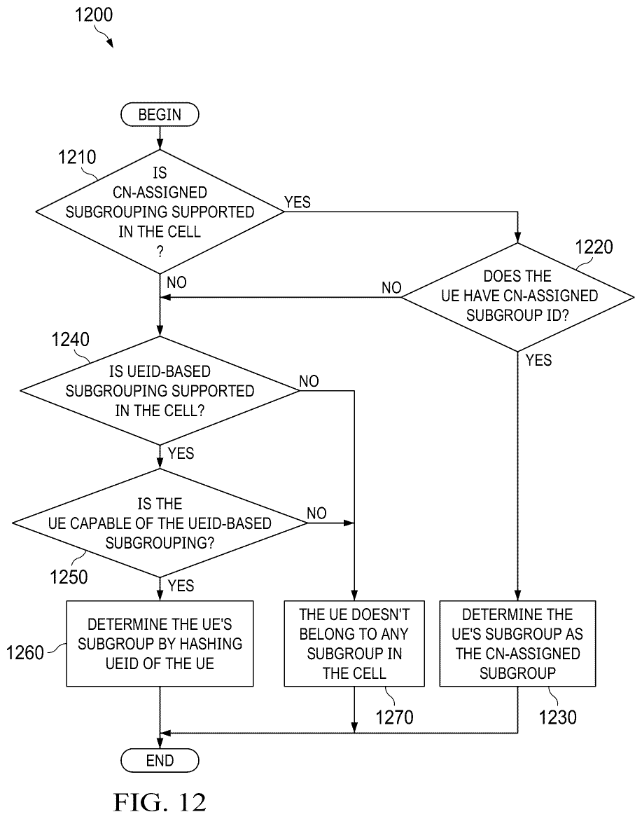

Operations 1100 may begin with the UE entering the RRC_IDLE state or the RRC_INACTIVE state (step 1110). For example, the UE enters the RRC_IDLE state or the RRC_INACTIVE state upon receiving an RRCRelease message from its serving gNB. Then, the UE may determine whether an indication stored in the UE context indicates that the use of PEI in paging the UE is enabled or not (step 1120), the indication being received and stored in the UE context before the UE enters the RRC_IDLE state or the RRC_INACTIVE state. In response to determining that the stored indication indicates that the use of PEI in paging the UE is enabled in step 1120, the UE may further determine whether the use of PEI in paging is supported in the cell that the UE currently camps in (step 1130). For example, if PEI-related configuration information is present in the SI being broadcasted in the cell that the UE currently camps in, the use of PEI in paging is supported in the cell; otherwise, the use of PEI in paging isn't supported in the cell. In response to determining that the use of PEI in paging is supported in the cell in step 1130, the UE may further determine whether the UE belongs to any subgroups being configured in the cell (step 1140). Detailed operations in step 1140 are further described as operations 1200 and illustrated in FIG. 12.

In response to determining that the UE belongs to a subgroup being configured in the cell, the UE may also identify a subgroup ID associated with the subgroup. Then, during each DRX cycle configured for the UE, the UE may first monitor an PEI-O associated with the UE for a PEI, the PEI indicating that the subgroup of the UE is being paged (step 1150). For example, a PEI indicates that the subgroup of the UE is being paged if the subgroup ID of the UE is included in the PEI. As another example, a PEI indicates that the subgroup of the UE is being paged if a bit within a bitmap carried in the PEI is set to a value indicating the paging, the position of the bit within the bitmap corresponding to the subgroup ID associated with the subgroup that the UE belongs to. In response to receiving the PEI during its PEI-O, the UE may further monitor a subsequent PO within the same DRX cycle and associated with the UE for a paging DCI, uses scheduling information in the received paging DCI to decode PDSCH to retrieve a paging message, and determines whether the UE is actually being paged in accordance with the paging message retrieved (step 1160). On the other hand, in response to not receiving the PEI during its PEI-O, the UE may return to a deep sleep mode until a time to wake up for monitoring the PEI-O in the next DRX cycle, without a need for monitoring its PO for paging DCI or paging message during the current DRX cycle.

In response to determining that the stored indication indicates that the use of PEI in paging the UE is disabled in step 1120, or in response to determining that the use of PEI in paging isn't supported in the cell that the UE currently camps in in step 1130, or in response to determining that the UE doesn't belongs to any subgroups being configured in the cell that the UE currently camps in in step 1140, the UE may monitor the PO associated with the UE in each DRX cycle of the UE for a paging DCI, use scheduling information in the received paging DCI to decode PDSCH to retrieve a paging message, and determine whether the UE is actually being paged in accordance with the paging message retrieved (step 1170). Finally, in response to receiving a paging message which includes the UEID of the UE in step 1160 or step 1170, the UE may determine that it is being paged, and based thereon, initiate a random access procedure, e.g., by sending a PRACH to the gNB, from which the paging message is received (step 1180). Then, operations 1100 may end.

FIG. 12 illustrates a flow chart of operations 1200 occurring in a UE according to some embodiments. Operations 1200 may be indicative of operations occurring in a UE, as the UE determines whether the UE belongs to any subgroups being configured (for PEI) in a cell that the UE currently camps in (i.e., step 1140 in operations 1100, as illustrated in FIG. 11).

Operations 1200 may begin with the UE determining whether the CN-assigned subgrouping method is supported in the cell (step 1210). For example, the support (or non-support) of the CN-assigned subgrouping method in the cell may be implicitly indicated by two parameters broadcasted in the SI, namely subgroupsNumPerPO and subgroupsNumforUEID, as described before. In response to determining that the CN-assigned subgrouping method is supported in the cell, the UE may further determine whether the UE has a CN-assigned subgroup ID (step 1220). For example, the CN-assigned subgroup ID may be assigned by the serving of the AMF to the UE and provided to the UE in a REGISTRATION ACCEPT message sent during a registration request procedure, as illustrated in FIG. 7A. In response to determining that the UE has the CN-assigned subgroup ID in step 1220, the UE may determine that it belongs to a subgroup associated with the CN-assigned subgroup ID of the UE (step 1230). Then, operations 1200 may end.

In response to determining that the CN-assigned subgrouping method isn't supported in the cell in step 1210 or in response to determining that the UE doesn't have any CN-assigned subgroup ID in step 1220, the UE may further determine whether the UEID-based subgrouping method is supported in the cell (step 1240). For example, the support (or non-support) of the UEID-assigned subgrouping method in the cell may be implicitly indicated by the parameter referred to as subgroupsNumforUEID broadcasted (or a lack of) in the SI, as described before. In response to determining that the UEID-based subgrouping method is supported in the cell in step 1240, the UE may further determine whether the UE is capable of the UEID-based subgrouping method (step 1250). In response to determining that the UE is capable of the UEID-based subgrouping method, the UE may determine the subgroup that the UE belongs to by hashing the UEID of the UE to produce a subgroup ID of the subgroup that the UE belongs to (step 1260), as described before. Then, operations 1200 may end.

In response to determining that the UEID-based subgrouping method isn't supported in the cell in step 1240 or in response to determining that the UE is incapable of the UEID-based subgrouping method in step 1250, the UE may determine that it doesn't belong to any subgroups configured for the cell (step 1270). Then, operations 1200 may end.

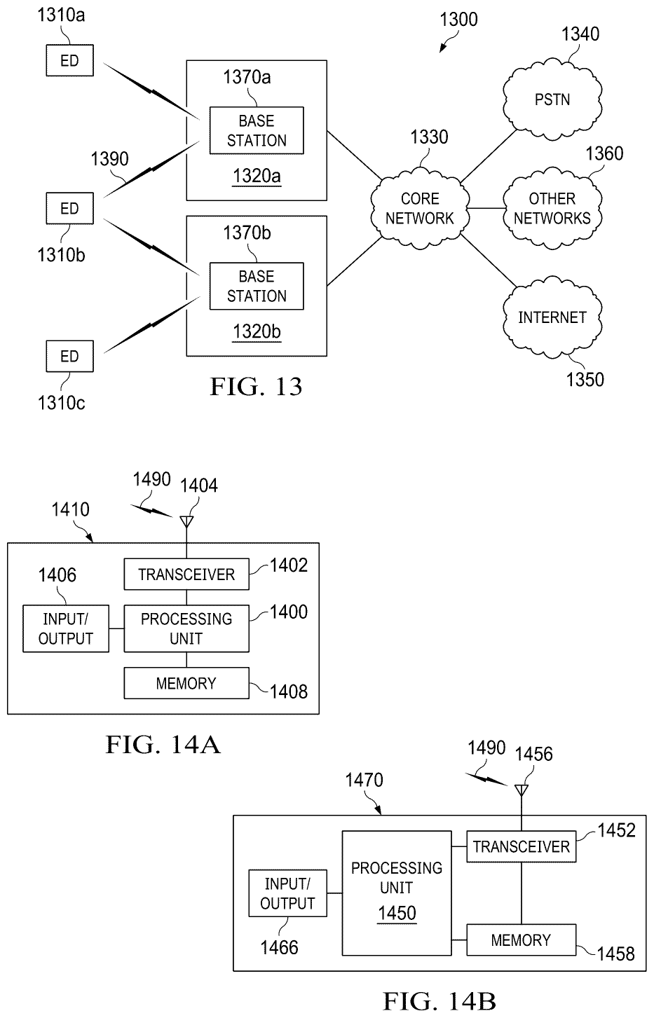

FIG. 13 illustrates an example communication system 1300. In general, the system 1300 enables multiple wireless or wired users to transmit and receive data and other content. The system 1300 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 1300 includes electronic devices (ED) 1310a-1310c, radio access networks (RANs) 1320a-1320b, a core network 1330, a public switched telephone network (PSTN) 1340, the Internet 1350, and other networks 1360. While certain numbers of these components or elements are shown in FIG. 13, any number of these components or elements may be included in the system 1300.

The EDs 1310a-1310c are configured to operate or communicate in the system 1300. For example, the EDs 1310a-1310c are configured to transmit or receive via wireless or wired communication channels. Each ED 1310a-1310c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 1320a-1320b here include base stations 1370a-1370b, respectively. Each base station 1370a-1370b is configured to wirelessly interface with one or more of the EDs 1310a-1310c to enable access to the core network 1330, the PSTN 1340, the Internet 1350, or the other networks 1360. For example, the base stations 1370a-1370b may include (or be) one or more of several well-known devices, such as a base transceiver station (BTS), a Node-B (NodeB), an evolved NodeB (eNB), a Next Generation (NG) NodeB (gNB), a gNB centralized unit (gNB-CU), a gNB distributed unit (gNB-DU), a Home NodeB, a Home eNodeB, a site controller, an access point (AP), or a wireless router. The EDs 1310a-1310c are configured to interface and communicate with the Internet 1350 and may access the core network 1330, the PSTN 1340, or the other networks 1360.

In the embodiment shown in FIG. 13, the base station 1370a forms part of the RAN 1320a, which may include other base stations, elements, or devices. Also, the base station 1370b forms part of the RAN 1320b, which may include other base stations, elements, or devices. Each base station 1370a-1370b operates to transmit or receive wireless signals within a particular geographic region or area, sometimes referred to as a “cell.” In some embodiments, multiple-input multiple-output (MIMO) technology may be employed having multiple transceivers for each cell.

The base stations 1370a-1370b communicate with one or more of the EDs 1310a-1310c over one or more air interfaces 1390 using wireless communication links. The air interfaces 1390 may utilize any suitable radio access technology.

It is contemplated that the system 1300 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 1320a-1320b are in communication with the core network 1330 to provide the EDs 1310a-1310c with voice, data, application, Voice over Internet Protocol (VoIP), or other services. Understandably, the RANs 1320a-1320b or the core network 1330 may be in direct or indirect communication with one or more other RANs (not shown). The core network 1330 may also serve as a gateway access for other networks (such as the PSTN 1340, the Internet 1350, and the other networks 1360). In addition, some or all of the EDs 1310a-1310c may include functionality for communicating with different wireless networks over different wireless links using different wireless technologies or protocols. Instead of wireless communication (or in addition thereto), the EDs may communicate via wired communication channels to a service provider or switch (not shown), and to the Internet 1350.

Although FIG. 13 illustrates one example of a communication system, various changes may be made to FIG. 13. For example, the communication system 1300 could include any number of EDs, base stations, networks, or other components in any suitable configuration.

FIGS. 14A and 14B illustrate example devices that may implement the methods and teachings according to this disclosure. In particular, FIG. 14A illustrates an example ED 1410, and FIG. 14B illustrates an example base station 1470. These components could be used in the system 1300 or in any other suitable system.

As shown in FIG. 14A, the ED 1410 includes at least one processing unit 1400. The processing unit 1400 implements various processing operations of the ED 1410. For example, the processing unit 1400 could perform signal coding, data processing, power control, input/output processing, or any other functionality enabling the ED 1410 to operate in the system 1300. The processing unit 1400 also supports the methods and teachings described in more detail above. Each processing unit 1400 includes any suitable processing or computing device configured to perform one or more operations. Each processing unit 1400 could, for example, include a microprocessor, microcontroller, digital signal processor, field programmable gate array, or application specific integrated circuit.

The ED 1410 also includes at least one transceiver 1402. The transceiver 1402 is configured to modulate data or other content for transmission by at least one antenna or NIC (Network Interface Controller) 1404. The transceiver 1402 is also configured to demodulate data or other content received by the at least one antenna 1404. Each transceiver 1402 includes any suitable structure for generating signals for wireless or wired transmission or processing signals received wirelessly or by wire. Each antenna 1404 includes any suitable structure for transmitting or receiving wireless or wired signals. One or multiple transceivers 1402 could be used in the ED 1410, and one or multiple antennas 1404 could be used in the ED 1410. Although shown as a single functional unit, a transceiver 1402 could also be implemented using at least one transmitter and at least one separate receiver.

The ED 1410 further includes one or more input/output devices 1406 or interfaces (such as a wired interface to the Internet 1350). The input/output devices 1406 facilitate interaction with a user or other devices (network communications) in the network. Each input/output device 1406 includes any suitable structure for providing information to or receiving information from a user, such as a speaker, microphone, keypad, keyboard, display, or touch screen, including network interface communications.

In addition, the ED 1410 includes at least one memory 1408. The memory 1408 stores instructions and data used, generated, or collected by the ED 1410. For example, the memory 1408 could store software or firmware instructions executed by the processing unit(s) 1400 and data used to reduce or eliminate interference in incoming signals. Each memory 1408 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 14B, the base station 1470 includes at least one processing unit 1450, at least one transceiver 1452, which includes functionality for a transmitter and a receiver, one or more antennas 1456, at least one memory 1458, and one or more input/output devices or interfaces 1466. A scheduler, which would be understood by one skilled in the art, is coupled to the processing unit 1450. The scheduler could be included within or operated separately from the base station 1470. The processing unit 1450 implements various processing operations of the base station 1470, such as signal coding, data processing, power control, input/output processing, or any other functionality. The processing unit 1450 can also support the methods and teachings described in more detail above. Each processing unit 1450 includes any suitable processing or computing device configured to perform one or more operations. Each processing unit 1450 could, for example, include a microprocessor, microcontroller, digital signal processor, field programmable gate array, or application specific integrated circuit.

Each transceiver 1452 includes any suitable structure for generating signals for wireless or wired transmission to one or more EDs or other devices. Each transceiver 1452 further includes any suitable structure for processing signals received wirelessly or by wire from one or more EDs or other devices. Although shown combined as a transceiver 1452, a transmitter and a receiver could be separate components. Each antenna 1456 includes any suitable structure for transmitting or receiving wireless or wired signals. While a common antenna 1456 is shown here as being coupled to the transceiver 1452, one or more antennas 1456 could be coupled to the transceiver(s) 1452, allowing separate antennas 1456 to be coupled to the transmitter and the receiver if equipped as separate components. Each memory 1458 includes any suitable volatile or non-volatile storage and retrieval device(s). Each input/output device 1466 facilitates interaction with a user or other devices (network communications) in the network. Each input/output device 1466 includes any suitable structure for providing information to or receiving/providing information from a user, including network interface communications.

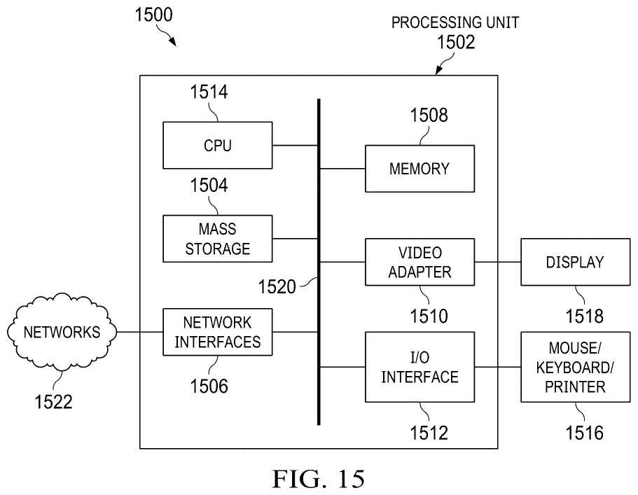

FIG. 15 is a block diagram of a computing system 1500 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1500 includes a processing unit 1502. The processing unit includes a central processing unit (CPU) 1514, memory 1508, and may further include a mass storage device 1504, a video adapter 1510, and an I/O interface 1512 connected to a bus 1520.

The bus 1520 may be one or more of any type of several bus architectures including a memory bus or memory controller, a peripheral bus, or a video bus. The CPU 1514 may comprise any type of electronic data processor. The memory 1508 may comprise any type of non-transitory system memory such as static random access memory (SRAM), dynamic random access memory (DRAM), synchronous DRAM (SDRAM), read-only memory (ROM), or a combination thereof. In an embodiment, the memory 1508 may include ROM for use at boot-up, and DRAM for program and data storage for use while executing programs.

The mass storage 1504 may comprise any type of non-transitory storage device configured to store data, programs, and other information and to make the data, programs, and other information accessible via the bus 1520. The mass storage 1504 may comprise, for example, one or more of a solid state drive, hard disk drive, a magnetic disk drive, or an optical disk drive.

The video adapter 1510 and the I/O interface 1512 provide interfaces to couple external input and output devices to the processing unit 1502. As illustrated, examples of input and output devices include a display 1518 coupled to the video adapter 1510 and a mouse, keyboard, or printer 1516 coupled to the I/O interface 1512. Other devices may be coupled to the processing unit 1502, and additional or fewer interface cards may be utilized. For example, a serial interface such as Universal Serial Bus (USB) (not shown) may be used to provide an interface for an external device.

The processing unit 1502 also includes one or more network interfaces 1506, which may comprise wired links, such as an Ethernet cable, or wireless links to access nodes or different networks. The network interfaces 1506 allow the processing unit 1502 to communicate with remote units via the networks. For example, the network interfaces 1506 may provide wireless communication via one or more transmitters/transmit antennas and one or more receivers/receive antennas. In an embodiment, the processing unit 1502 is coupled to a local-area network 1522 or a wide-area network for data processing and communications with remote devices, such as other processing units, the Internet, or remote storage facilities.

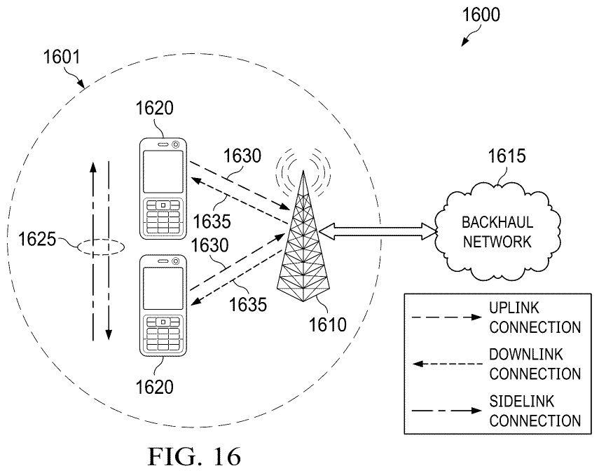

FIG. 16 illustrates an example communications system 1600. Communications system 1600 includes an access node 1610 serving user equipments (UEs) with coverage 1601, such as UEs 1620. In a first operating mode, communications to and from a UE passes through access node 1610 with a coverage area 1601. The access node 1610 is connected to a backhaul network 1615 for connecting to the internet, operations and management, and so forth. In a second operating mode, communications to and from a UE do not pass through access node 1610, however, access node 1610 typically allocates resources used by the UE to communicate when specific conditions are met. Communications between a pair of UEs 1620 can use a sidelink connection (shown as two separate one-way connections 1625). In FIG. 16, the sideline communication is occurring between two UEs operating inside of coverage area 1601. However, sidelink communications, in general, can occur when UEs 1620 are both outside coverage area 1601, both inside coverage area 1601, or one inside and the other outside coverage area 1601. Communication between a UE and access node pair occur over uni-directional communication links, where the communication links between the UE and the access node are referred to as uplinks 1630, and the communication links between the access node and UE is referred to as downlinks 1635.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, a removing unit or module, or a selecting unit or module. The respective units or modules may be hardware, software, or a combination thereof. For instance, one or more of the units or modules may be an integrated circuit, such as field programmable gate arrays (FPGAs) or application-specific integrated circuits (ASICs).

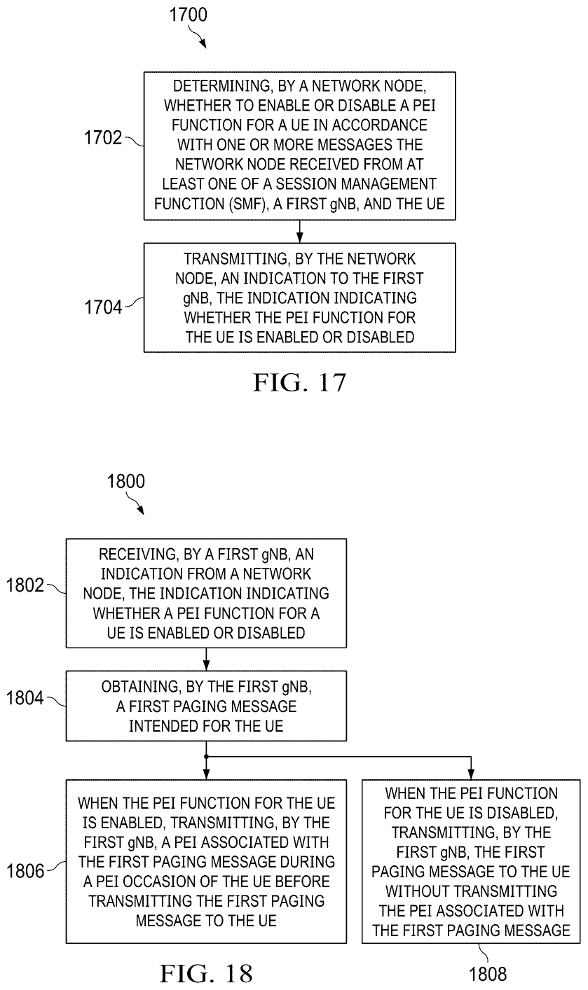

FIG. 17 illustrates a method 1700 performed by a network node according to some embodiments. At step 1702, the network node may determine whether to enable or disable a PEI function for a UE in accordance with one or more messages the network node received from at least one of a SMF, a first gNB, and the UE. At step 1704, the network node may transmit an indication to the first gNB, the indication indicating whether the PEI function for the UE is enabled or disabled. In various embodiments, the network node is an AMF. In various embodiments, the AMF, the SMF, and the first gNB are configured to serve the UE.

FIG. 18 illustrates a method 1800 performed by a first gNB according to some embodiments. At step 1802, the first gNB may receive an indication from a network node, the indication indicating whether a PEI function for a UE is enabled or disabled. At step 1804, the first gNB may obtain a first paging message intended for the UE. When the PEI function for the UE is enabled, the method proceeds to step 1806, where the first gNB may transmit a PEI associated with the first paging message during a PEI occasion of the UE before transmitting the first paging message to the UE, the PEI indicating a subgroup that the UE belongs to. When the PEI function for the UE is disabled, the method proceeds to step 1808, where the first gNB may transmit the first paging message to the UE without transmitting the PEI associated with the first paging message. In some embodiments, the network node is an AMF serving the UE, the first gNB obtaining the first paging message either by receiving the first paging message from the AMF, for a CN-initiated paging, or by generating the first message, for an RAN-initiated paging, which is initiated by the first gNB as the anchor gNB of the UE. In some other embodiments, the network node is a second gNB serving the UE prior to the first gNB serving the UE, the UE having been handed over from the second gNB to the first gNB prior to being released into the RRC_IDLE state or the RRC_INACTIVE state, the first gNB obtaining the first paging message either by receiving the first paging message from the serving AMF of the UE, for a CN-initiated paging, or by generating the first message, for an RAN-initiated paging, which is initiated by the first gNB as the anchor gNB of the UE. In yet some other embodiments, the network node is a third gNB, the third gNB being the anchor gNB of the UE and being a neighboring gNB of the first gNB, the first gNB obtaining the first paging message by receiving it (along with the indication) from the third gNB, for an RAN-initiated paging, which is initiated by the third gNB (as the anchor gNB of the UE) and participated by the first gNB (as a neighboring gNB of the anchor gNB) upon request.

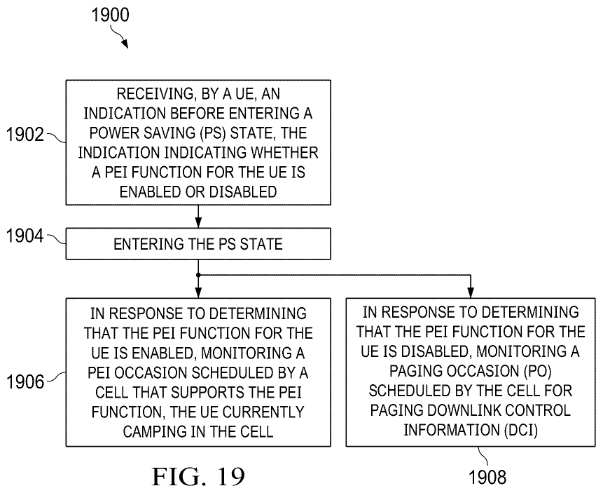

FIG. 19 illustrates a method 1900 performed by a UE according to some embodiments. At step 1902, the UE may receive an indication before entering a power saving (PS) state, the indication indicating whether a PEI function for the UE is enabled or disabled. At step 1904, the UE may enter the PS state. At step 1906, in response to determining that the PEI function for the UE is enabled, the UE may monitor a PEI occasion scheduled by a cell that supports the PEI function (for a PEI indicating a subgroup that the UE belongs to) before determining whether there is a need to monitor a paging occasion (PO) scheduled by the cell for paging downlink control information (DCI), the UE currently camping in the cell. At step 1908, in response to determining that the PEI function for the UE is disabled, the UE may monitor the PO scheduled by the cell for the paging DCI without monitoring the PEI occasion.

The present disclosure may describe or illustrate an embodiment device that includes multiple components. Such description also is not intended to be construed in a limiting sense. In various embodiments, persons skilled in the art may implement specific devices that utilize all of the components shown or only a subset of the components, and levels of integration may vary from device to device. Furthermore, a device may contain multiple instances of a component, such as multiple processing units, processors, memories, transmitters, receivers, etc.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

1. A method comprising:
determining, by a network node, whether to enable or disable a paging early indication (PEI) function for a user equipment (UE) in accordance with one or more messages the network node received from at least one of a session management function (SMF), a first next generation Node B (gNB), or the UE; and
transmitting, by the network node, an indication to at least one of the first gNB or the UE, the indication indicating whether the PEI function for the UE is enabled or disabled.

2. The method of claim 1, the network node being an access and mobility management function (AMF), and the AMF, the SMF, and the first gNB being configured to serve the UE.

3. The method of claim 1, the determining whether to enable or disable the PEI function for the UE being based on whether or not a quality of service (QOS) requirement can be satisfied when the PEI function for the UE is enabled, the QoS requirement being a most stringent delay requirement among one or more data protocol data unit (PDU) sessions on the UE and being determined in accordance with at least one of a PDU session establishment message, a PDU session modification message, or a PDU session release message from the SMF.

4. The method of claim 1, further comprising:
receiving a request message from the UE, the request message including at least one of a request type information element (IE) and a radio resource control (RRC) establishment cause IE, the request type IE and the RRC establishment cause IE indicating whether a service requested by the UE is an emergency service, wherein the network node determines to enable the PEI function for the UE in response to the service requested being a non-emergency service and the network node determines to disable the PEI function for the UE in response to the service requested being the emergency service.

5. The method of claim 1, further comprising:
receiving a request from the UE, the request indicating whether the UE requests to enable or disable the PEI function, wherein the network node determines to enable the PEI function for the UE in response to the UE requesting to enable the PEI function and the network node determines to disable the PEI function for the UE in response to the UE requesting to disable the PEI function.

6. The method of claim 1, the indication being included in one of an INITIAL CONTEXT SETUP message, a UE CONTEXT MODIFICATION REQUEST message, a PDU SESSION RESOURCE SETUP REQUEST message, a PDU SESSION RESOURCE MODIFY REQUEST message, a PDU SESSION RESOURCE RELEASE COMMAND message, or a PAGING message transmitted from the network node to the first gNB.

7. The method of claim 1, further comprising:
transmitting the indication to a second gNB, wherein the UE is configured to be handed over from the first gNB to the second gNB, and wherein the indication is included in a HANDOVER REQUEST message transmitted from the network node to the second gNB.

8. A method comprising:
receiving, by a first next generation Node B (gNB), an indication from a network node, the indication indicating whether a paging early indication (PEI) function for a user equipment (UE) is enabled or disabled;
obtaining, by the first gNB, a first paging message for the UE;
when the PEI function for the UE is enabled, transmitting, by the first gNB, a PEI associated with the first paging message during a PEI occasion of the UE before transmitting the first paging message to the UE, the PEI associated with the first paging message indicating a subgroup that the UE belongs to; and
when the PEI function for the UE is disabled, transmitting, by the first gNB, the first paging message to the UE without transmitting the PEI associated with the first paging message.

9. The method of claim 8, the network node being an access and mobility management function (AMF) configured to serve the UE, the first gNB being a serving gNB of the UE, and the indication being included in one of an INITIAL CONTEXT SETUP message, a UE CONTEXT MODIFICATION REQUEST message, a PDU SESSION RESOURCE SETUP REQUEST message, a PDU SESSION RESOURCE MODIFY REQUEST message, a PDU SESSION RESOURCE RELEASE COMMAND message, a first HANDOVER REQUEST message, or a second PAGING message transmitted from the AMF to the first gNB.

10. The method of claim 8, the network node being a second gNB configured to hand over the UE to the first gNB, and the indication being included in a second HANDOVER REQUEST message transmitted from the second gNB to the first gNB.

11. The method of claim 8, further comprising:
transmitting a third HANDOVER REQUEST message to a third gNB, the third HANDOVER REQUEST message including the indication, the first gNB being configured to hand over the UE to the third gNB.

12. The method of claim 8, further comprising:
transmitting a first radio access network (RAN) PAGING message to a fourth gNB, the first RAN paging message including the indication and the first paging message for the UE, the first paging message being generated by the first gNB, the fourth gNB being configured to transmit the first paging message in response to receiving the first RAN PAGING message.

13. The method of claim 8, further comprising:
transmitting the indication to the UE, the indication included in a dedicated radio resource control (RRC) signaling, wherein the dedicated RRC signaling is either an RRC RELEASE message or an RRC RECONFIGURATION message.

14. The method of claim 8, further comprising:
receiving a second RAN PAGING message from the network node, the network node being a neighboring gNB of the first gNB, the second RAN paging message including the indication and the first paging message for the UE, the first gNB being configured to transmit the first paging message in response to receiving the second RAN PAGING message.

15. A method comprising:
receiving, by a user equipment (UE), an indication before entering a power saving (PS) state, the indication indicating whether a paging early indication (PEI) function for the UE is enabled or disabled;
entering the PS state;
in response to determining that the PEI function for the UE is enabled, monitoring a PEI occasion scheduled by a cell that supports the PEI function, the UE currently camping in the cell; and
in response to determining that the PEI function for the UE is disabled, monitoring a paging occasion (PO) scheduled by the cell for paging downlink control information (DCI).

16. The method of claim 15, further comprising:
determining whether or not a PEI is received during the PEI occasion; and
performing one of:
in response to determining that the PEI is not received during the PEI occasion or that the PEI is received during the PEI occasion and the PEI does not indicate a subgroup associated with the UE, returning to a sleep mode until a next PEI occasion, or
in response to determining that the PEI is received during the PEI occasion and the PEI indicates the subgroup associated with the UE, monitoring the PO associated with the PEI for the paging DCI.

17. The method of claim 15, further comprising:
receiving the paging DCI;
demodulating and decoding a physical downlink shared channel (PDSCH) in accordance with scheduling information included in the paging DCI to retrieve a paging message; and
in response to determining that the paging message includes an identity of the UE, initiating a random access procedure.

18. The method of claim 15, wherein the PS state is an RRC_IDLE state or an RRC_INACTIVE state.

19. The method of claim 15, wherein the indication is included in one of an RRC RELEASE message or an RRC RECONFIGURATION message transmitted from a next generation Node B (gNB) serving the UE.

20. The method of claim 15, the indication is included in one of a REGISTRATION ACCEPT message or a SERVICE ACCEPT message transmitted from an access and mobility management function (AMF) serving the UE.

21. The method of claim 20, further comprising:
transmitting a request to the AMF to either enable or disable the PEI function for the UE before receiving the indication, the request being included in one of a SERVICE REQUEST message or a REGISTRATION REQUEST message transmitted to the AMF.
